(19) United States
(12) Patent Application Publication
(10) Pub. No.: US 2019/0126942 A1
(43) Pub. Date: May 2, 2019

(54) ASSISTANCE SYSTEM, PORTABLE TERMINAL, AND VEHICULAR DEVICE

(71) Applicant: DENSO CORPORATION, Kariya-city, Aichi-pref. (JP)

(72) Inventors: Hirotaka GOTO, Kariya-city, Aichi-pref. (JP); Akihiro HAYASHI, Kariya-city, Aichi-pref. (JP)

(21) Appl. No.: 16/096,051

(22) PCT Filed: Feb. 28, 2017
(86) PCT No.: PCT/JP2017/007589

§ 371 Date: Oct. 24, 2018

(30) Foreign Application Priority Data
Apr. 27, 2016 (JP) 2016-89756
Dec. 1, 2016 (JP) 2016-234372

(51) Int. Cl. B60W 50/14; G05D 1/00; B60W 10/04; B60W 10/18; B60W 10/20; B60W 30/18; B60W 40/08; B60Q 9/00

(52) U.S. Cl. CPC B60W 50/14; G05D 1/0231; B60W 10/04; B60W 10/18; B60W 10/20; B60W 30/18; B60W 40/08; G05D 1/0061; B60Q 9/00; G05D 2201/0213; B60W 2050/146; B60W 2710/30; B60W 2400/00; B60W 2540/04; G05D 1/0088

(57) ABSTRACT

An assistance system includes: an vehicular device for a vehicle that performs an autonomous driving operation, and allows a driver action during the autonomous driving operation; and a portable terminal that is carried by the driver of the vehicle and connected to the vehicular device to communicate with the vehicular device. The vehicular device or the portable terminal includes an operation determination section that determines whether the portable terminal is being operated. The portable terminal includes a display unit that performs an assistance display for assisting an execution of the driver action which is required during the autonomous driving operation when the driver action is required during the autonomous driving operation, and the operation determination section determines that the portable terminal is being operated.

### CROSS REFERENCE TO RELATED APPLICATIONS

This application is based on Japanese Patent Applications No. 2016-89756 filed on Apr. 27, 2016, and NO. 2016-234372 filed on Dec. 1, 2016, the disclosures of which are incorporated herein by reference.

### TECHNICAL FIELD

The present disclosure relates to an assistance system, a portable terminal, and a vehicular device that assist the execution of a driver action that is necessary during automatic driving, the driver action being at least any of an operation, a response, and a confirmation by a driver.

### BACKGROUND ART

As a conventional technique, there is known a technique that performs switching between automatic driving which automatically controls acceleration, braking, and steering of a vehicle and manual driving in which a driver manually performs a driving operation. Further, there is known a technique that notifies a driver of switching from automatic driving to manual driving. For example, Patent Literature 1 discloses a technique that performs a notification from a liquid crystal display of a navigation device when automatic driving is switched to manual driving.

### PRIOR ART LITERATURES

### Patent Literature

Patent Literature 1: JP-2016-50900-A

### SUMMARY OF INVENTION

It is assumed that, in the future, an operation of a portable terminal, such as a multifunctional portable telephone, a notebook PC, or a tablet terminal, carried into a vehicle by a driver is permitted during automatic driving. When an operation of a portable terminal carried into the vehicle by the driver is permitted during automatic driving, it may be hard for the driver who is absorbed in the operation of the portable terminal to notice a notification from the navigation device in the technique disclosed in Patent Literature 1. Thus, there is a problem in that the driver is late in noticing the notification of switching from automatic driving to manual driving, and a driving change from automatic driving to manual driving is not smoothly performed.

It is an object of the present disclosure to provide a driving change assistance system, a portable terminal, and a vehicular device that enable smoother execution of a driver action that is necessary during automatic driving, the driver action being at least any of an operation, a response, and a confirmation by a driver, even when the driver is operating a portable terminal carried into a vehicle.

According to a first aspect of the present disclosure, an assistance system includes: an vehicular device for a vehicle that performs an autonomous driving operation for automatically controlling an acceleration operation, a braking operation and a steering operation, and allows a driver action including at least one of an operation, a response and a confirmation by a driver during the autonomous driving operation; and a portable terminal that is carried by the driver of the vehicle and connected to the vehicular device to communicate with the vehicular device. The vehicular device or the portable terminal includes an operation determination section that determines whether the portable terminal is being operated. The portable terminal includes a display unit that performs an assistance display for assisting an execution of the driver action which is required during the autonomous driving operation when the driver action is required during the autonomous driving operation, and the operation determination section determines that the portable terminal is being operated.

According to a second aspect of the present disclosure, a portable terminal carried by a driver of a vehicle, includes: a communication unit for the vehicle that performs an autonomous driving operation for automatically controlling an acceleration operation, a braking operation and a steering operation, and allows a driver action including at least one of an operation, a response and a confirmation by the driver during the autonomous driving operation, the communication unit being connected to an vehicular device to perform communication with the vehicular device for transmitting a request notification, which indicates that the driver action is required when the driver action is required during the autonomous driving operation; an operation determination section that determines whether the portable terminal is being operated when the communication unit receives the request notification; and a display unit that performs an assistance display for assisting an execution of the driver action which is required during the autonomous driving operation when the operation determination section determines that the portable terminal is being operated.

According to a third aspect of the present disclosure, an vehicular device for a vehicle that performs an autonomous driving operation for automatically controlling an acceleration operation, a braking operation and a steering operation, and allows a driver action including at least one of an operation, a response and a confirmation by a driver during the autonomous driving operation, the vehicular device being connected to a portable terminal carried by the driver of the vehicle to perform communication with the portable terminal, the vehicular device includes: a determination information acquisition section that acquires determination information, for determining whether the portable terminal is being operated, from the portable terminal when the driver action is required during the autonomous driving operation, and the vehicular device is connectable with the portable terminal; an operation determination section that determines whether the portable terminal is being operated, based on the determination information acquired by the determination information acquisition section; and an instruction processing section that transmits an instruction, for performing an assistance display that assists an execution of the driver action which is required during the autonomous driving operation, to the portable terminal when the operation determination section determines that the portable terminal is being operated.

According to the assistance system, the portable terminal, and the vehicular device, when a driver action that is at least any of an operation, a response, and a confirmation by a driver is necessary during autonomous driving and it is determined that the portable terminal is being operated, the portable terminal performs an assistance display that assists the execution of the driver action that is necessary during autonomous driving. Since the portable terminal is carried by the driver of the vehicle, the portable terminal is carried into the vehicle during autonomous driving. Further, the assistance display is performed in the portable terminal when it is determined that the portable terminal is being operated. Thus, even when the driver is absorbed in the operation of the portable terminal during autonomous driving, the driver can notice the assistance display. Thus, even when the driver is operating the portable terminal carried into the vehicle, a driver action that is necessary during autonomous driving, the driver action being at least any of an operation, a response, and a confirmation by the driver, can be more smoothly executed.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram illustrating an example of a schematic configuration of an assistance system;

FIG. 2 is a diagram illustrating an example of a schematic configuration of a vehicle-side unit;

FIG. 3 is a diagram illustrating an example of a schematic configuration of an HCU;

FIG. 4 is a flowchart illustrating an example of the flow of an operation necessity-related process in the HCU in a first embodiment;

FIG. 5 is a diagram illustrating an example of a schematic configuration of a portable terminal;

FIG. 6 is a diagram illustrating an example of an assistance display in the first embodiment;

FIG. 7 is a diagram illustrating an example of the assistance display in the first embodiment;

FIG. 8 is a flowchart illustrating an example of the flow of a request corresponding process in a portable terminal 2;

FIG. 9 is a diagram illustrating an example of an assistance display in a first modification;

FIG. 10 is a diagram illustrating an example of the assistance display in the first modification;

FIG. 11 is a flowchart illustrating an example of the flow of an operation necessity-related process in an HCU 11 in the first modification;

FIG. 12 a diagram illustrating an example of an assistance display in a second modification;

FIG. 13 is a diagram illustrating an example of the assistance display in the second modification;

FIG. 14 a diagram illustrating an example of an assistance display in a fourth modification;

FIG. 15 is a diagram illustrating an example of the assistance display in the fourth modification;

FIG. 16 a diagram illustrating an example of an assistance display in a fifth modification;

FIG. 17 is a diagram illustrating an example of the assistance display in the fifth modification;

FIG. 18 is a diagram for describing an example of a display mode in a case where display timings of a plurality of types of assistance information items overlap each other;

FIG. 19 is a diagram illustrating an example of the schematic configuration of the assistance system;

FIG. 20 is a diagram illustrating an example of the schematic configuration of the vehicle-side unit;

FIG. 21 is a diagram illustrating an example of the schematic configuration of the HCU;

FIG. 22 is a diagram illustrating an example of the schematic configuration of the portable terminal;

FIG. 23 is a diagram illustrating an example of the schematic configuration of the portable terminal; and

FIG. 24 is a diagram illustrating an example of the schematic configuration of the HCU.

### EMBODIMENTS FOR CARRYING OUT INVENTION

A plurality of embodiments and modifications for the disclosure will be described with reference to the drawings. For convenience of description, a part having the same function as a part illustrated in the drawing used in the preceding description will be designated by the same reference sign as the preceding part between the embodiments and modifications, and description thereof may be omitted. Description in the other embodiments and/or modifications can be referred to for the parts having the same reference signs.

The embodiments and modifications described below correspond to a region where left-hand traffic is designated by law. In a region where right-hand traffic is designated by law, right and left are inverted relative to the following embodiments.

### First Embodiment

<Schematic Configuration of Assistance System 3>

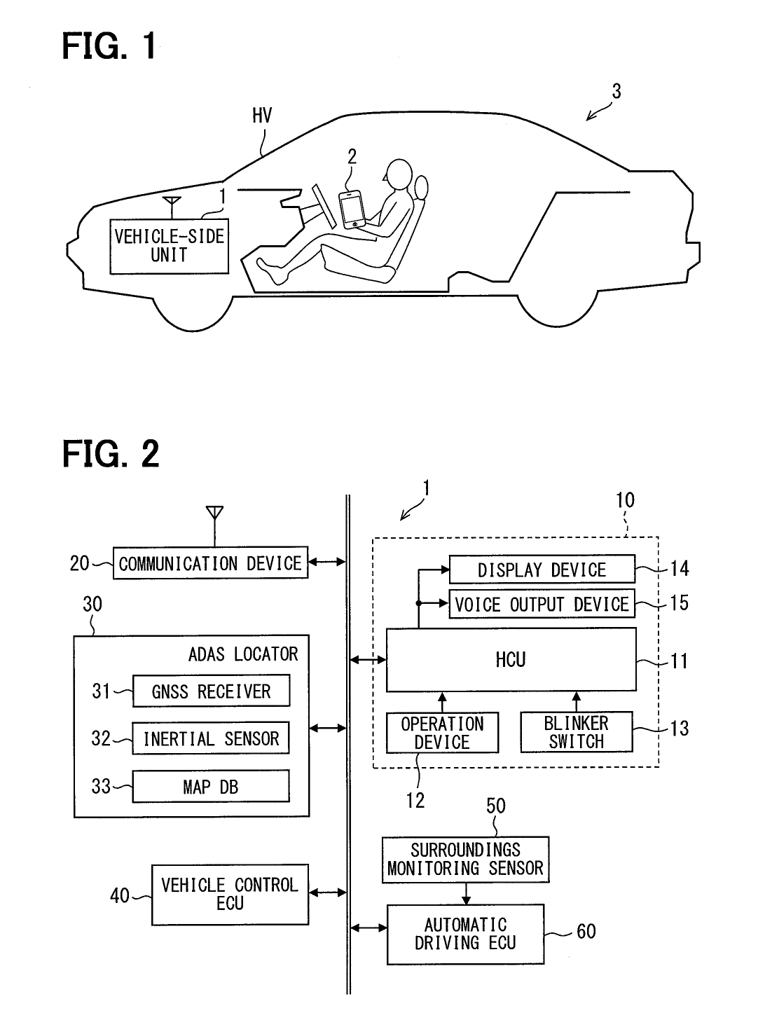

Hereinbelow, an example of a first embodiment of the present disclosure will be described with reference to the drawings. As illustrated in FIG. 1, an assistance system 3 includes a vehicle-side unit 1 and a portable terminal 2. The vehicle-side unit 1 is mounted on a vehicle HV which performs automatic driving which automatically controls acceleration, braking, and steering and connected to the portable terminal 2 to perform communication. The vehicle HV is an automobile and capable of performing switching between automatic driving and manual driving in which a driver manually performs a driving operation.

The portable terminal 2 is carried by a driver of the vehicle HV and carried into the vehicle HV when the driver gets on the vehicle HV. The portable terminal 2 may be a terminal that is portable by the driver and has a display function. Examples of the portable terminal 2 include a multifunctional portable telephone, a tablet terminal, a notebook PC, an electronic book terminal, and a smart watch. In the first embodiment, description will be made with an example in which a multifunctional portable telephone such as a smartphone is used as the portable terminal 2.

<Schematic Configuration of Vehicle-Side Unit 1>

Next, a schematic configuration of the vehicle-side unit 1 will be described with reference to FIG. 2. The vehicle-side unit 1 is mounted on an automatic driving vehicle. As illustrated in FIG. 2, the vehicle-side unit 1 includes a human machine interface (HMI) system 10, a communication device 20, an advanced driver assistance systems (ADAS) locator 30, a vehicle control ECU 40, a surroundings monitoring sensor 50, and an automatic driving ECU 60. The HMI system 10, the communication device 20, the ADAS locator 30, the vehicle control ECU 40, and the automatic driving ECU 60 are connected to, for example, an in-vehicle LAN and capable of exchanging information therebetween by communication.

The communication device 20 directly performs communication with the portable terminal 2 in accordance with a short-range wireless communication standard (hereinbelow, referred to as short-range wireless communication). A range of the short-range wireless communication may be, for example, approximately less than 1 m radius. The communication device 20 may be configured to transmit and receive a signal in accordance with a short-range wireless communication standard such as Bluetooth (registered trademark) or ZigBee (registered trademark). Hereinbelow, description will be made with an example in which a signal is transmitted and received in accordance with the Bluetooth standard. In view of power consumption reduction, the communication device 20 is more preferably configured to transmit and receive a signal in accordance with the Bluetooth Low Energy standard.

In the first embodiment, the following description will be made assuming that pairing of the portable terminal 2 carried by the driver of the vehicle HV with the communication device 20 has already been executed. When the communication device 20 is connected to the portable terminal 2, the communication device 20 outputs information acquired from the portable terminal 2 to the in-vehicle LAN and transmits information transmitted from the HCU 11 through the in-vehicle LAN to the portable terminal 2.

The ADAS locator 30 includes a global navigation satellite system (GNSS) receiver 31, an inertial sensor 32 and a map database (hereinbelow, referred to as a DB) 33 in which map data is stored. The GNSS receiver 31 receives positioning signals from a plurality of artificial satellites. The inertial sensor 32 includes, for example, a three-axis gyroscopic sensor and a three-axis acceleration sensor. The map DB 33 is a nonvolatile memory in which map data such as link data, node data, a road shape, and a construction is stored.

The ADAS locator 30 successively measures the position of the vehicle HV equipped with the ADAS locator 30 by combining positioning signals received by the GNSS receiver 31 with a result of measurement by the inertial sensor 32. A travel distance obtained from pulse signals which are successively output from a wheel speed sensor mounted on the vehicle HV may also be used in the measurement of the vehicle position. Then, the measured vehicle position is output to the in-vehicle LAN. The ADAS locator 30 also reads map data from the map DB 33 and outputs the read map data to the in-vehicle LAN. The map data may be acquired from the outside of the vehicle HV using an vehicular communication module, such as a DCM, which is mounted on the own vehicle.

The vehicle control ECU 40 is an electronic control device that performs acceleration and deceleration control and steering control of the vehicle HV.

The vehicle control ECU 40 includes a steering ECU which performs steering control, a power unit control ECU which performs acceleration and deceleration control, and a brake ECU. The vehicle control ECU 40 acquires a detection signal output from each of sensors mounted on the vehicle HV, such as an accelerator position sensor, a brake pedal force sensor, a steering angle sensor, and a wheel speed sensor and outputs a control signal to each of traveling control devices such as an electronic control throttle, a brake actuator, and an electric power steering (EPS) motor. The vehicle control ECU 40 is capable of outputting a detection signal of each of the above sensors to the in-vehicle LAN.

The surroundings monitoring sensor 50 detects moving objects such as a pedestrian, an animal other than a human, a bicycle, a motorcycle, and another vehicle and also stationary objects such as a fallen object on a road, a guard rail, a curb, and a tree. In addition, the surroundings monitoring sensor 50 detects road markings such as a traveling lane marking and a stop line.

The surroundings monitoring sensor 50 is, for example, a surroundings monitoring camera that captures an image of a predetermined range around the vehicle HV or a sensor that transmits a probing wave to a predetermined range around the vehicle HV such as a millimeter wave radar, a sonar, or a light detection and ranging/laser imaging detection and ranging (LIDAR).

A stereo camera or a monocular camera may be used as the surroundings monitoring camera. The surroundings monitoring camera successively outputs successively-captured images to the automatic driving ECU 60 as sensing information. The sensor that transmits a probing wave such as a sonar, a millimeter wave radar, or a LIDAR successively outputs scanning results based on received signals which are obtained when reflected waves reflected by an obstacle are received to the automatic driving ECU 60 as sensing information. The surroundings monitoring camera and the millimeter wave radar may be used in combination in sensing ahead of the vehicle HV. That is, a plurality of types of surroundings monitoring sensors 50 may have overlapping sensing ranges.

The automatic driving ECU 60 recognizes a traveling environment of the own vehicle from the position of the own vehicle and map data acquired from the ADAS locator 30 and sensing information acquired from the surroundings monitoring sensor 50. The automatic driving ECU 60 generates a travel plan for causing the own vehicle to travel by automatic driving on the basis of the recognized travel environment. For example, the automatic driving ECU 60 generates a recommended route to a destination for the own vehicle as a long and medium-term travel plan. Further, the automatic driving ECU 60 generates a short-term travel plan for traveling following the recommended route. Specifically, the execution of steering for a lane change, acceleration and deceleration for speed control, and steering and braking for avoiding collision is determined.

The automatic driving ECU 60 causes the vehicle control ECU 40 to automatically perform acceleration, braking, and/or steering of the own vehicle in accordance with the generated travel plan to perform a driving operation on behalf of the driver. The automatic driving ECU 60 is capable of performing switching between execution and inexecution of automatic driving. The inexecution of automatic driving indicates that main control systems such as the brake, the steering, the throttle, and the driving force of the own vehicle are not automated, but all operated by the driver. That is, the inexecution of automatic driving corresponds to manual driving. The switching between the execution and the inexecution of automatic driving in the automatic driving ECU 60 may be autonomously performed in accordance with, for example, the end of traveling in an automatic driving section, a recognized traveling environment, or a fault in sensing in the surroundings monitoring sensor 50. Alternatively, the switching between the execution and the inexecution of automatic driving may be performed in accordance with an input operation to an operation device 12 (described below) by the driver.

As illustrated in FIG. 2, the HMI system 10 includes a human machine interface control unit (HCU) 11, the operation device 12, a blinker switch 13, a display device 14, and a voice output device 15. The HMI system 10 receives an input operation from the driver of the vehicle HV and presents information to the driver of the vehicle HV.

The operation device 12 is a switch group operated by the driver of the vehicle HV. The operation device 12 is used for performing various settings. For example, the operation device 12 includes a steering switch which is disposed in a spoke part of the steering of the own vehicle and a touch switch which is integrated with the display device 14.

The blinker switch 13 is a switch for detecting an operation of a blinker lever which is an operation member for performing a lamp turning-on operation of a direction indicator. The blinker switch 13 outputs a blinker signal during a right or left turn according to the operation of the blinker lever.

The display device 14 performs information presentation by displaying text and/or an image. For example, the display device 14 includes a combination meter, a center information display (CID), and a head-up display (HUD). The voice output device 15 performs information presentation by outputting a voice. For example, the voice output device 15 includes an audio speaker.

The HCU 11 includes a CPU, a volatile memory, a nonvolatile memory, an I/O, and a bus which connects the CPU, the volatile memory, the nonvolatile memory, and the I/O. The HCU 11 executes various processes by executing control programs stored in the nonvolatile memory. For example, the HCU 11 causes the display device 14 and/or the voice output device 15 to perform information presentation. Some or all of the functions executed by the HCU 11 may be configured as hardware by one or more ICs. The details of the HCU 11 will be described below.

<Schematic Configuration of HCU 11>

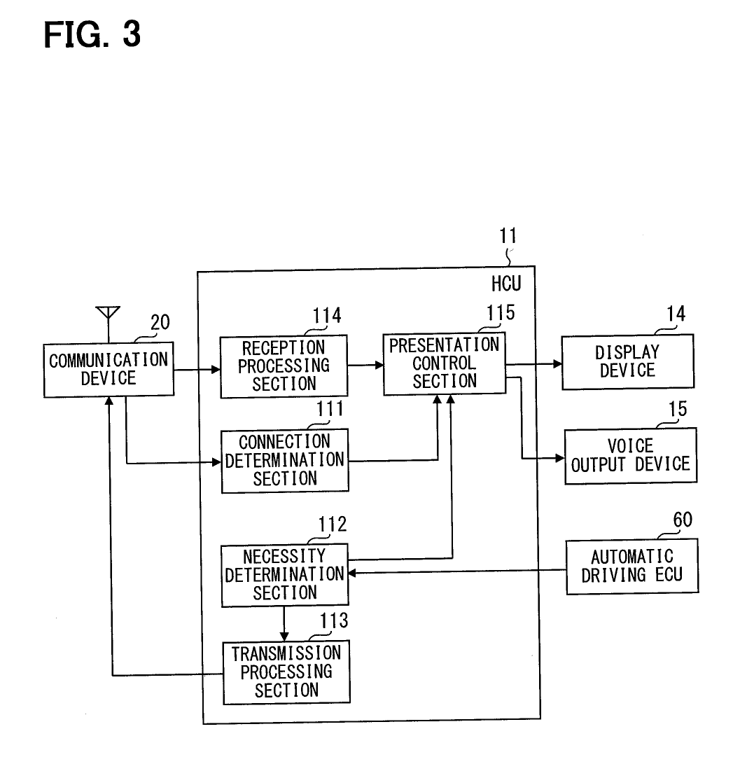

A schematic configuration of the HCU 11 will be described with reference to FIG. 3. As illustrated in FIG. 3, the HCU 11 includes a connection determination section 111, a necessity determination section 112, a transmission processing section 113, a reception processing section 114, and a presentation control section 115.

The connection determination section 111 monitors the state of the communication device 20 to determine whether the communication device 20 is connectable with the portable terminal 2. The necessity determination section 112 monitors the automatic driving ECU 60 to determine whether a driver action that is at least any of an operation, a response, and a confirmation by the driver is necessary during automatic driving. In the present embodiment, the following description will be made with an example in which when the automatic driving ECU 60 performs switching from automatic driving to manual driving and a driving operation by the driver is necessary, it is determined that a driver action is necessary. When the necessity determination section 112 determines that a driver action is necessary, the necessity determination section 112 outputs a request notification indicating that the driver action is necessary to the transmission processing section 113. In the example of the present embodiment, a request notification indicating that a driving operation by the driver is necessary is output to the transmission processing section 113. The request notification may include the details of the necessary driver action. The driver action described herein is a driving operation by the driver, the driving operation being necessary in switching to manual driving.

The transmission processing section 113 outputs information to the communication device 20 to cause the communication device 20 to transmit the information to the portable terminal 2. When the transmission processing section 113 acquires a request notification from the necessity determination section 112, the transmission processing section 113 outputs the request notification to the communication device 20 to cause the communication device 20 to transmit the request notification to the portable terminal 2. The transmission processing section 113 corresponds to the notification processing section.

When the communication device 20 acquires the request notification from the transmission processing section 113, the communication device 20 transmits the request notification to the portable terminal 2 when the communication device 20 is in connection with the portable terminal 2. On the other hand, when the communication device 20 is not in connection with the portable terminal 2, the communication device 20 attempts to establish connection with the portable terminal 2. The communication device 20 transmits the request notification to the portable terminal 2 when the connection is successful and does not transmit the request notification to the portable terminal 2 when the connection is failed. When the portable terminal 2 receives the request notification from the communication device 20, the portable terminal 2 determines whether the portable terminal 2 is being operated and transmits a result of the determination whether the portable terminal 2 is being operated (hereinbelow, referred to as portable terminal operation information to the communication device 20.

Also when the communication device 20 is connectable with a communication terminal other than the portable terminal 2, the communication device 20 may identify the portable terminal 2, establish connection with the portable terminal 2, and transmit a request notification to the portable terminal 2. For example, even when the communication device 20 is in connection with a communication terminal other than the portable terminal 2, the communication device 20 may stop the connection with the communication terminal other than the portable terminal 2, establish connection with the portable terminal 2, and transmit a request notification to the portable terminal 2 when the communication device 20 is connectable with the portable terminal 2. In this case, identification information such as an ID of the portable terminal 2 of the driver may be registered in the communication terminal 20 so that a request notification is transmitted only to the registered portable terminal 2. The configuration including the communication device 20 and the HCU 11 corresponds to the vehicular device. As another example, the communication device 20 may transmit a request notification to all connectable communication terminals including the portable terminal 2 without identifying the portable terminal 2. In this case, the HCU 11 corresponds to the vehicular device.

When the communication device 20 receives portable terminal operation information transmitted from the portable terminal 2, the reception processing section 114 acquires the portable terminal operation information and outputs the portable terminal operation information to the presentation control section 115. When the necessity determination section 112 determines that a driver action is necessary, the presentation control section 115 performs information presentation that assists the execution of the driver action that is necessary during automatic driving (hereinbelow, referred to as assistance presentation) in accordance with a condition.

As an example, when the connection determination section 111 determines that connection with the portable terminal 2 is impossible, the presentation control section 115 causes the display device 14 and/or the voice output device 15 to perform assistance presentation. Also when the connection determination section 111 determines that connection with the portable terminal 2 is possible and portable terminal operation information acquired by the reception processing section 114 indicates that the portable terminal 2 is not being operated, the presentation control section 115 causes the display device 14 and/or the voice output device 15 to perform assistance presentation. On the other hand, when the connection determination section 111 determines that connection with the portable terminal 2 is possible, but portable terminal operation information acquired by the reception processing section 114 indicates that the portable terminal 2 is being operated, the presentation control section 115 does not cause the display device 14 and/or the voice output device 15 to perform assistance presentation. As an example of the assistance presentation, a display and/or a voice output that urges a driving change from automatic driving to manual driving may be performed.

<Operation Necessity-Related Process in HCU 11>

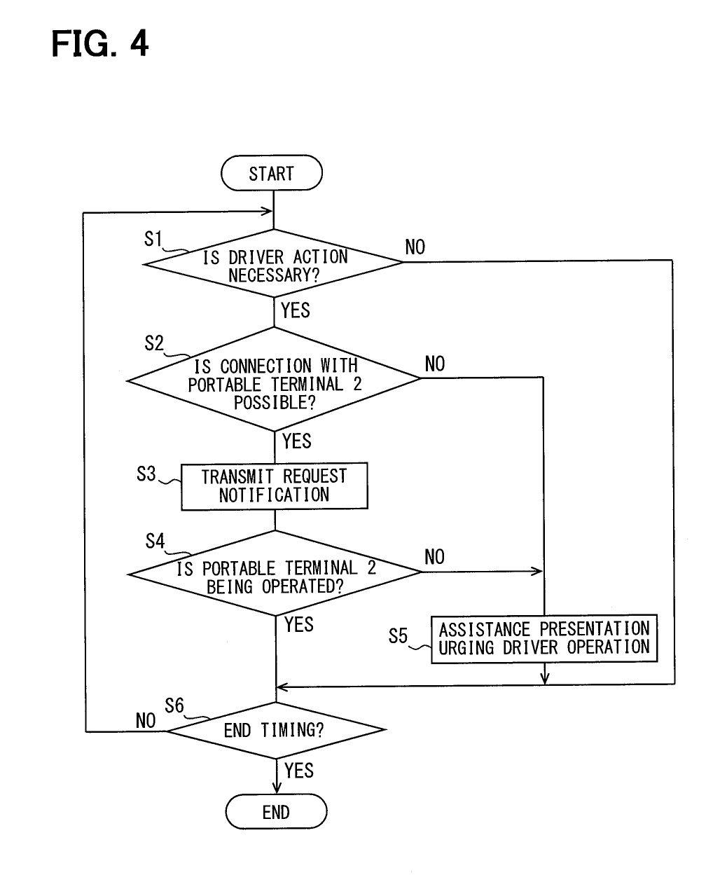

An example of the flow of a process corresponding to whether an operation by the driver is necessary during automatic driving in the HCU 11 (hereinbelow, referred to as an operation necessity-related process) will be described with reference to a flowchart of FIG. 4. The flowchart of FIG. 4 may be started when automatic driving of the vehicle HV is started.

First, when the necessity determination section 112 determines that a driver action is necessary in step S1 (YES in S1), the process shifts to step S2. On the other hand, when the necessity determination section 112 determines that no driver action is necessary (NO in S1), the process shifts to step S6. When the connection determination section 111 determines that connection with the portable terminal 2 is possible in step S2 (YES in S2), the process shifts to step S3. On the other hand, when the connection determination section 111 determines that connection with the portable terminal 2 is impossible (NO in S2), the process shifts to step S5. When connection with the portable terminal 2 is impossible, it is not possible to transmit a request notification from the communication device 20 to the portable terminal 2. Thus, no request notification is transmitted.

In step S3, the transmission processing section 113 outputs a request notification acquired from the necessity determination section 112 to the communication device 20 to cause the communication device 20 to transmit the request notification to the portable terminal 2. When portable terminal operation information acquired by the reception processing section 114 from the portable terminal 2 through the communication device 20 indicates that the portable terminal 2 is being operated in step S4 (YES in S4), the process shifts to step S6. On the other hand, when the portable terminal operation information indicates that the portable terminal 2 is not being operated (NO in step S4), the process shifts to step S5.

In step S5 which is performed when connection with the portable terminal 2 is impossible in S2, or when the portable terminal operation information indicates that the portable terminal 2 is not being operated in S4, the presentation control section 115 causes the display device 14 and/or the voice output device 15 to perform assistance presentation. The presentation control section 115 corresponds to the voice output processing section.

When an end timing of the operation necessity-related process has come in step S6 (YES in S6), the operation necessity-related process is finished. On the other hand, when the end timing of the operation necessity-related process has not come (NO in S6), the process returns to S1 to repeatedly perform the process. Examples of the end timing of the operation necessity-related process include a timing when the vehicle HV is switched from automatic driving to manual driving and a timing when an ignition power source of the vehicle HV is turned off.

<Schematic Configuration of Portable Terminal 2>

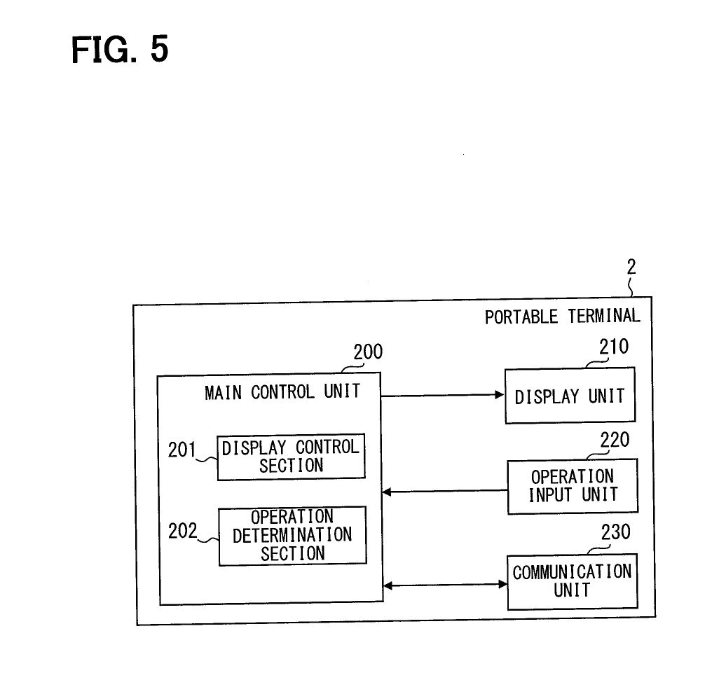

Next, a schematic configuration of the portable terminal 2 will be described with reference to FIG. 5. As illustrated in FIG. 5, the portable terminal 2 includes a main control unit 200, a display unit 210, an operation input unit 220, and a communication unit 230. The display unit 210 displays text and/or an image in accordance with an instruction of the main control unit 200. The operation input unit 220 receives an operation input from a user. The operation input unit 220 may be a mechanical switch or a touch panel integrated with the display unit 210. The communication unit 230 communicates with the communication device 20 of the vehicle-side unit 1. When the communication unit 230 receives a request notification from the communication device 20, the communication unit 230 outputs the received request notification to the main control unit 200. When the main control unit 200 outputs information, the communication unit 230 transmits the information to the communication device 20.

The main control unit 200 includes a CPU, a volatile memory, a nonvolatile memory, an I/O, and a bus which connects the CPU, the volatile memory, the nonvolatile memory, and the I/O. The main control unit 200 executes various processes by executing control programs stored in the nonvolatile memory. The main control unit 200 includes a display control section 201 and an operation determination section 202 as functional blocks. Some or all of the functions executed by the main control unit 200 may be configured as hardware by one or more ICs.

The display control section 201 causes the display unit 210 to perform a display corresponding to an application software program (hereinbelow, referred to as an application) executed by the portable terminal 2. When the operation input unit 220 receives no operation for a certain time or more in a state in which the power of the portable terminal 2 is on, the display control section 201 temporarily stops the display in the display unit 210 and shifts to a sleep mode which reduces power consumption.

When the operation determination section 202 acquires a request notification output from the communication unit 230, that is, when the communication unit 230 receives a request notification, the operation determination section 202 determines whether the own terminal is being operated. As an example, the operation determination section 202 may determine that the own terminal is being operated when the display control section 201 has not shifted to the sleep mode and may determine that the own terminal is not being operated when the display control section 201 has shifted to the sleep mode. Alternatively, the operation determination section 202 may determine that the own terminal is not being operated when a certain time or more has elapsed after stop of the reception of an operation input in the operation input unit 220 and may determine that the own terminal is being operated when an elapsed time after stop of the reception of an operation input in the operation input unit 220 is less than the certain time.

When the operation determination section 202 determines whether the own terminal is being operated, the operation determination section 202 causes the communication unit 230 to transmit a result of the determination whether the own terminal is being operated (that is, the portable terminal operation information described above) to the communication device 20.

When the operation determination section 202 determines that the portable terminal 2 is being operated, the display control section 201 causes the display unit 210 to perform a display of information that assists the execution of a driver action that is necessary during automatic driving (hereinbelow, referred to as an assistance display). The display control section 201 may cause the display unit 210 to perform an assistance display corresponding to the details of the driver action included in the request notification. In the present embodiment, an assistance display that requests a driving operation by the driver necessary in switching to manual driving is performed. On the other hand, when the operation determination section 202 determines that the portable terminal 2 is not being operated, the display control section 201 does not cause the display unit 210 to perform an assistance display.

Examples of the type of the assistance display include a control-related request which requests an operation to the driver for vehicle control, a control-related suggestion which makes a suggestion to the driver for vehicle control, a control-unrelated suggestion which makes a suggestion unrelated to vehicle control to the driver, and information provision which provides the driver with information.

The control-related request is an assistance display that makes a request related to vehicle control. In other words, the control-related request is an assistance display that makes a request related to vehicle control that necessarily needs to be performed by the driver. An example of the control-related request includes an assistance display that requests a driving operation by the driver necessary in switching to manual driving, the assistance display being performed when the driving operation by the driver is necessary for switching from automatic driving to manual driving as described in the present embodiment and a first modification described below. As another example, there is an assistance display that requests approval by the driver for a lane change or merging, the assistance display being performed when a response such as approval by the driver for a lane change or merging that is indispensable for the own vehicle to continue traveling as described in second and fourth modifications described below is necessary.

When the driver makes an approval response to the control-related request, the response may be received by an operation member mounted on the own vehicle. For example, an input operation that finishes automatic driving may be received by the operation device 12 as a response to an assistance display that requests a driving operation by the driver for switching to manual driving. A lever operation in the direction of a lane change or merging may be received by the blinker lever as a response to an assistance display that requests approval by the driver for the lane change or merging. Further, an input operation that indicates permission may be received as the response by the operation device 12 such as the steering switch. It is preferred that the driver cannot make a response that rejects a control-related request to the display of the control-related request. As an example, when the timing of a lane changer or merging has come without approval of the driver to the request, the own vehicle may be temporarily stopped until the request is approved.

The display of the control-related request may be finished when a response that approves the request is received from the driver. As an example, when the operation device 12 or the blinker lever receives a response that complies with the request from the driver, the HCU 11 may transmit a signal to the portable terminal 2 to finish the display of the control-related request.

The control-related suggestion is an assistance display that makes a suggestion related to vehicle control. In other words, the control-related suggestion is an assistance display that makes a suggestion related to vehicle control that does not necessarily need to be performed by the driver. The control-related suggestion corresponds to an assistance display that assists an inquiry requesting a response of the driver. An example of the control-related suggestion includes an assistance display that suggests a lane change or passing, the assistance display being performed when approval by the driver for the lane change or passing that is dispensable for the own vehicle to continue traveling is necessary as described in the second modification described below. The control-related suggestion further includes an assistance display that suggests a stop on a road shoulder, the assistance display being performed when approval by the driver for the stop on the road shoulder with an approach of an emergency vehicle is necessary as described in a third modification described below.

When the driver makes an approval response to the display of the control-related suggestion, the response may be received by an operation member mounted on the own vehicle. For example, a lever operation in the direction of a lane change or a stop on a road shoulder may be received by the blinker lever as a response that approves the suggestion to the assistance display that suggests the lane change or the stop on the road shoulder. Further, an input operation that indicates permission may be received as a response that approves the suggestion by the operation device 12 such as the steering switch.

On the other hand, also when the driver makes a rejection response to the display of the control-related suggestion, the response may be received by an operation member mounted on the own vehicle. For example, an input operation that indicates a rejection may be received as a response that rejects the suggestion by the operation device 12 such as the steering switch. No response that approves the suggestion within a certain time after the performance of the display of the control-related suggestion may be received as a response that rejects the suggestion by the HCU 11.

The display of the control-related suggestion may be finished when a response that approves the suggestion is received from the driver or when a response that rejects the suggestion is received from the driver. In a case where the configuration in which no response that approves the suggestion within a certain time after the performance of the display of the control-related suggestion is received as a response that rejects the suggestion is employed, the display of the control-related suggestion is finished when no response that approves the suggestion is performed within the certain time after the display of the control-related suggestion is performed. Alternatively, when the control-related suggestion becomes invalid such as when a preceding vehicle to be passed makes a lane change or accelerates or when the own vehicle goes out of a route of an emergency vehicle, the display of the control-related suggestion may be finished. Also when the display of the control-related suggestion is finished, the HCU 11 may transmit a signal to the portable terminal 2 to finish the display of the control-related suggestion.

Although it is preferred that a response that approves or rejects the control-related suggestion be received by the operation member mounted on the own vehicle, the present disclosure is not limited to the configuration in which the response is received by the operation member mounted on the own vehicle. For example, when a voice recognition unit is mounted on the vehicle HV or the portable terminal 2 has a voice recognition function, an approval or rejection response by voice may be voice-recognized to receive the response that approves or rejects the suggestion.

The control-unrelated suggestion is an assistance display that makes a suggestion unrelated to vehicle control. In other words, the control-unrelated suggestion is an assistance display that makes a suggestion unrelated to immediate vehicle control that does not necessarily need to be performed by the driver. The control-unrelated suggestion also corresponds to the assistance display that assists an inquiry requesting a response of the driver. An example of the control-unrelated suggestion includes an assistance display that suggests a stop-by at an available stop-by point, the assistance display being performed when approval by the driver for the stop-by at the available stop-by point is necessary during automatic driving as described in a fifth modification described below. As another example, there is an assistance display that suggests a route change of automatic driving, the assistance display being performed when a response such as approval or selection by the driver for the route change of automatic driving is necessary as described in a sixth modification described below. The case where selection by the driver is necessary refers to a case where a control-unrelated suggestion that is difficult to respond to only by approval or rejection is performed such as a case where selection to a suggestion of a plurality of candidates is necessary.

When the driver makes an approval, selection, or rejection response to the display of the control-unrelated suggestion, the response may be received by an operation member mounted on the own vehicle or the operation input unit 220 of the portable terminal 2. For example, when an approval, selection, or rejection response is received by an operation member mounted on the own vehicle, the operation device 12 such as the touch switch integrated with the display device 14 may receive the response.

When an approval, selection, or rejection response to the control-unrelated suggestion is received by the operation input unit 220 of the portable terminal 2, the touch panel integrated with the display unit 210 may receive the response. For example, an operation of a button displayed on a screen of the touch panel, the button indicating approval or rejection, may be received as a response that approves or rejects the control-unrelated suggestion. Further, an operation that selects one of a plurality of candidates displayed on the screen of the touch panel may be received as a response that makes a selection with respect to the control-unrelated suggestion. When the assistance display on the screen of the touch panel includes a button that closes the assistance display, an operation of the closing button may be received as a response that rejects the control-unrelated suggestion. Alternatively, a so-called swipe operation with respect to the assistance display on the screen of the touch panel may be received as a response that rejects the control-unrelated suggestion. No approval or selection response to the suggestion within a certain time after the performance of the display of the control-unrelated suggestion may be received as a response that rejects the suggestion.

The display of the control-unrelated suggestion may be finished when an approval, selection, or rejection response is received from the driver. Further, in a manner similar to the case of the display of the control-related suggestion, the display of the control-unrelated suggestion may be finished when no approval or selection response to the suggestion is performed within a certain time after the display of the control-unrelated suggestion is performed. When the operation member mounted on the own vehicle receives a response that rejects the control-unrelated suggestion, the HCU 11 may transmit a signal to the portable terminal 2 to finish the display of the control-unrelated suggestion.

The reception of an approval, selection, or rejection response to the control-unrelated suggestion is not necessarily limited to the configuration that receives the response by the operation member mounted on the own vehicle or the operation input unit 220 of the portable terminal 2. For example, when a voice recognition unit is mounted on the vehicle HV or the portable terminal 2 has a voice recognition function, an approval, selection, or rejection response by voice may be voice-recognized to receive the approval, selection, or rejection response.

The information provision is an assistance display that provides information related to the operation of the vehicle HV. In other words, the information provision is an assistance display that provides information related to the operation of the vehicle HV and that is enough to be confirmed by the driver. The information provision corresponds to an assistance display that assists an inquiry requesting a confirmation to the driver. An example of the information provision includes an assistance display that notifies a changed estimated destination arrival time, the assistance display being performed when an estimated destination arrival time is changed by a certain time or more as described in a seventh modification described below.

When the driver makes a response that indicates a confirmation to the display of the information provision, the response indicating the confirmation may be received by an operation member mounted on the own vehicle or the operation input unit 220 of the portable terminal 2. For example, when the response that indicates the confirmation is received by an operation member mounted on the own vehicle, the operation device 12 such as the touch switch integrated with the display device 14 may receive the response.

When the response that indicates the confirmation is received by the operation input unit 220 of the portable terminal 2, the touch panel integrated with the display unit 210 may receive the response. For example, an operation of a button displayed on the screen of the touch panel, the button indicating a confirmed state, may be received as a response that indicates the confirmation. Further, when the assistance display on the screen of the touch panel includes a button that closes the assistance display, an operation of the closing button may be received as a response that indicates the confirmation. Alternatively, a so-called swipe operation with respect to the assistance display on the screen of the touch panel may be received as a response that indicates the confirmation.

The display of the information provision may be finished when a response that indicates a confirmation is received from the driver. Further, the display of the information provision may be finished when a certain time has elapsed after the performance of the display of the information provision. When the operation member mounted on the own vehicle receives a response that indicates the confirmation, the HCU 11 may transmit a signal to the portable terminal 2 to finish the display of the information provision.

The reception of a response indicating that information provision has been confirmed is not necessarily limited to the configuration that receives the response by the operation member mounted on the own vehicle or the operation input unit 220 of the portable terminal 2. For example, when a voice recognition unit is mounted on the vehicle HV or the portable terminal 2 has a voice recognition function, the response may be received by voice recognition.

A response from the driver to an assistance display related to immediate vehicle control such as a control-related request or a control-related suggestion is received by the operation member mounted on the own vehicle. On the other hand, a response from the driver to an assistance display unrelated to immediate vehicle control such as a control-unrelated suggestion or information provision can also be received by the portable terminal 2. According to the above configuration, in a condition where a driving operation by the driver is likely to become necessary such as a condition where an assistance display related to immediate vehicle control is performed, the driver operates the operation member mounted on the vehicle. Accordingly, a shift to the driving operation by the driver can be easily performed when the driving operation is necessary. On the other hand, in a condition where the driving operation by the driver is less likely to become necessary such as a condition where an assistance display unrelated to the immediate vehicle control is performed, the operation of the operation member mounted on the own vehicle is dispensable. Accordingly, troublesomeness for the driver who wishes to continue the operation of the portable terminal 2 can be reduced.

When an assistance display corresponding to the control-related request or the control-related suggestion is performed, it is preferred to also display text that alerts the driver to check the safety around the own vehicle by himself or herself. As an example, text such as “please approve after checking safety around” may be displayed.

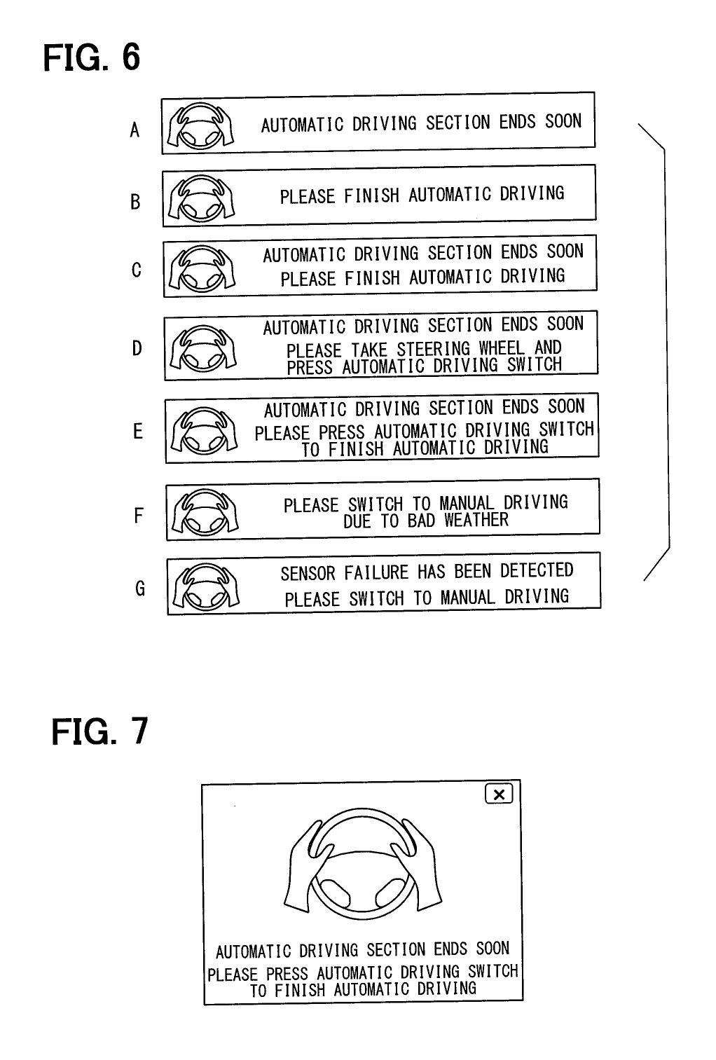

The assistance display may be displayed, for example, in a superimposed manner on a display corresponding to an application that has been executed since before the portable terminal 2 receives a request notification. For example, while a website is being viewed, an assistance display may be superimposed on a display of the web site. As an example of the assistance display, a banner display that is a combination of text with an icon as illustrated in A to G in FIG. 6 may be performed. Alternatively, a pop-up display that is a combination of text with an icon as illustrated in FIG. 7 may be performed. Further, an assistance display may be superimposed on the entire area of a display corresponding to an application. The screen may be divided, and an assistance display and a display corresponding to an application that has been executed since before the portable terminal 2 receives a request notification may be displayed on different screens.

<Request Corresponding Process in Portable Terminal 2>

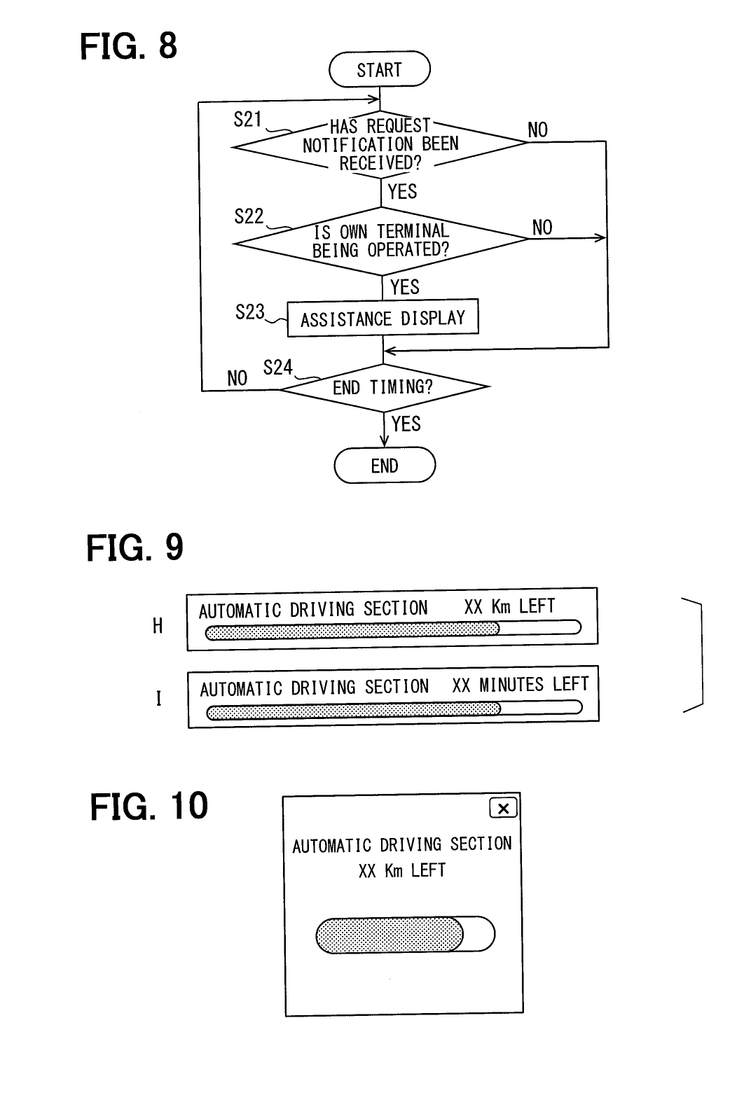

Here, an example of the flow of a process corresponding to a request notification (hereinbelow, referred to as a request corresponding process) in the portable terminal 2 will be described with reference to a flowchart of FIG. 8. The flowchart of FIG. 8 may be started when power of the portable terminal 2 is turned on.

First, when the communication unit 230 receives a request notification from the communication device 20 in step S21 (YES in S21), the process shifts to step S22. On the other hand, when no request notification is received (NO in S21), the process shifts to step S24.

In step S22, the operation determination section 202 determines whether the own terminal is being operated. When the operation determination section 202 determines that the own terminal is being operated (YES in S22), the process shifts to step S23. On the other hand, when the operation determination section 202 determines that the own terminal is not being operated (NO in S22), the process shifts to step S24. In step S23, the display control section 201 causes the display unit 210 to perform the assistance display described above.

When an end timing of the request corresponding process has come in step S24 (YES in S24), the request corresponding process is finished. On the other hand, when the end timing of the request corresponding process has not come (NO in S24), the process returns to S21 to repeatedly perform the process. An example of the end timing of the request corresponding process includes turning-off of the power of the portable terminal 2.

### Summary of First Embodiment

According to the configuration of the first embodiment, when the portable terminal 2 receives a request notification indicating that a driver action that is at least any of an operation, a response, and a confirmation by the driver is necessary during automatic driving from the vehicle-side unit 1 and the portable terminal 2 determines that the own terminal is being operated, the display unit 210 of the portable terminal 2 performs an assistance display. The portable terminal 2 receives a request notification from the vehicle-side unit 1 by short-range wireless communication. Thus, when the portable terminal 2 receives a request notification, the portable terminal 2 is carried into the vehicle HV. When it is determined that the portable terminal 2 is being operated, the display unit 210 of the portable terminal 2 performs an assistance display. Thus, even when the driver is absorbed in the operation of the portable terminal 2 during automatic driving, the driver can notice the assistance display. Thus, even when the driver is operating the portable terminal 2 carried into the vehicle HV, a driver action that is necessary during automatic driving can be more smoothly executed.

According to the configuration of the first embodiment, when the portable terminal 2 receives a request notification from the vehicle-side unit 1 and the portable terminal 2 determines that the own terminal is being operated, assistance presentation that assists the execution of an operation is not performed in the display device 14 and/or the voice output device 15 of the vehicle-side unit 1. Thus, no assistance presentation superimposed on the assistance display from the portable terminal 2 is performed from the vehicle side. Thus, the driver is less likely to have a troublesome feeling caused by assistance presentation superimposed on the assistance display.

According to the configuration of the first embodiment, when an action by the driver is necessary during automatic driving and the portable terminal 2 and the vehicle-side unit 1 are unconnectable, assistance presentation is performed in the display device 14 and/or the voice output device 15 of the vehicle-side unit 1. When the portable terminal 2 and the vehicle-side unit 1 are unconnectable, it is considered that the power of the portable terminal 2 is off or the portable terminal 2 is not carried into the vehicle HV. In this manner, in a condition where there is no possibility that the driver is absorbed in the operation of the portable terminal 2 during automatic driving, assistance presentation is performed from the display device 14 and/or the voice output device 15 on the vehicle side. Accordingly, an operation by the driver that is necessary during automatic driving can be more smoothly executed.

According to the configuration of the first embodiment, even when a driver action is necessary during automatic driving and the portable terminal 2 and the vehicle-side unit 1 are connectable, assistance presentation is performed in the display device 14 and/or the voice output device 15 of the vehicle-side unit 1 when the portable terminal 2 determines that the own terminal is not being operated. Thus, in a condition where the portable terminal 2 is not being operated and the driver is thus not absorbed in the operation of the portable terminal 2 during automatic driving, assistance presentation is performed from the display device 14 and/or the voice output device 15 on the vehicle side. Accordingly, a driver action that is necessary during automatic driving can be more smoothly executed.

First Modification

The first embodiment describes an example in a case where a time to switching to manual driving is relatively short as an example in a case where switching from automatic driving to manual driving is performed. However, the present disclosure is not necessarily limited thereto. For example, when a remaining distance and/or a remaining time to switching from automatic driving to manual driving becomes equal to or less than a set value and a driving operation by the driver is necessary in the switching to manual driving, the necessity determination section 112 may determine that a driver action is necessary during automatic driving (hereinbelow, referred to a first modification).

Hereinbelow, the configuration of the first modification of the present disclosure will be described. The necessity determination section 112 of the first modification acquires a remaining distance to an automatic driving section end on the basis of a travel plan generated in the automatic driving ECU 60. When the remaining distance or a remaining time calculated from the remaining distance is equal to or less than the set value, it may be determined that a driver action is necessary during automatic driving. The driver action is a driving operation by the driver, the driver operation being necessary in switching to manual driving. The remaining time may be calculated by the necessity determination section 112 from the remaining distance and an average vehicle speed. The set value described herein is settable in any manner.

In the configuration of the first modification, the remaining distance and/or the remaining time to switching from automatic driving to manual driving may also be transmitted when a request notification is transmitted from the vehicle-side unit 1 to the portable terminal 2, and the remaining distance and/or the remaining time may also be displayed when an assistance display is performed in the portable terminal 2. As an example of the assistance display in the first modification, a banner display that is a combination of text with an image as illustrated in FIG. 9 may be performed. In FIG. 9, “H” is an example in a case where the remaining distance to the automatic driving section end is shown, and “I” is an example in a case where the remaining time to the automatic driving section end is shown. Alternatively, a pop-up display that is a combination of text with an image as illustrated in FIG. 10 may be performed. FIG. 10 illustrates an example in a case where the remaining distance to the automatic driving section end is shown.

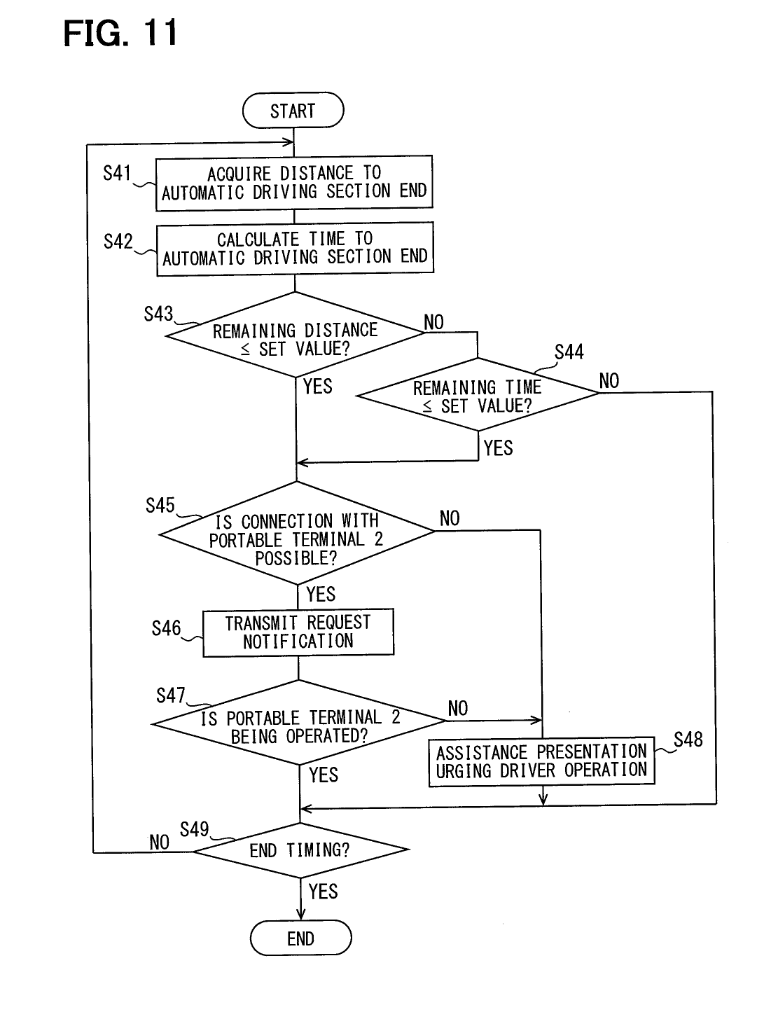

Here, an example of the flow of an operation necessity-related process in the HCU 11 in the first modification will be described with reference to FIG. 11. The flowchart of FIG. 11 may also be started when automatic driving of the vehicle HV is started.

First, in step S41, the necessity determination section 112 acquires a remaining distance to an automatic driving section end from the automatic driving ECU 60. In step S42, the necessity determination section 112 calculates a remaining time to the automatic driving section end from the remaining distance acquired in S41 and an average vehicle speed of the vehicle HV during automatic driving.

When the remaining distance acquired in S41 is equal to or less than a set value in step S43 (YES in S43), the process shifts to step S45. On the other hand, when the remaining distance is longer than the set value (NO in step S43), the process shifts to step S44. When the remaining time calculated in S42 is equal to or less than a set value in step S44 (YES in S44), the process shifts to step S45. On the other hand, when the remaining time is longer than the set value (NO in step S44), the process shifts to step S49. The set value used in S43 differs from the set value used in S44.

The processes of step S45 to step S49 are similar to the processes of S2 to S6 described above. When YES is determined in S43 and a request notification is transmitted in S46, the remaining distance acquired in S41 is also transmitted to the portable terminal 2. When the portable terminal 2 which has received the request notification and the remaining distance determines that the own terminal is being operated, an assistance display that indicates the remaining distance is performed. On the other hand, when YES is determined in S44 and a request notification is transmitted in S46, the remaining time calculated in S42 is also transmitted to the portable terminal 2. When the portable terminal 2 which has received the request notification and the remaining time determines that the own terminal is being operated, an assistance display that indicates the remaining time is performed.

Second Modification

The first embodiment and the first modification describe the configuration in which when the automatic driving ECU 60 performs switching from automatic driving to manual driving, the necessity determination section 112 determines that a driver action is necessary during automatic driving. However, the present disclosure is not limited thereto. For example, when approval by the driver is necessary in a lane change and passing during automatic driving, the necessity determination section 112 may determine that a driver action is necessary during automatic driving when the lane change or passing is performed during the automatic driving (hereinbelow, referred to as a second modification).

Hereinbelow, the configuration of the second modification of the present disclosure will be described. The necessity determination section 112 of the second modification determines that a driver action is necessary during automatic driving when it is necessary to make a lane change indispensable for the vehicle HV to automatically continue traveling on the basis of a travel plan generated in the automatic driving ECU 60. As an example, a case where it is necessary to shift to a dedicated lane for a right or left turn and a case where there is a lane regulation due to a construction work ahead of the own vehicle correspond to the case where it is necessary to make a lane change indispensable for continuing traveling.

Further, the necessity determination section 112 determines that a driver action is necessary during automatic driving when a lane change or passing that is not necessarily indispensable for the vehicle HV to automatically continue traveling is suggested on the basis of a traveling environment of the own vehicle recognized by the automatic driving ECU 60. As an example, a case where traveling in which the distance between the own vehicle and the preceding vehicle is less than a threshold continues for a certain time or more corresponds to the case where a lane change or passing that is not necessarily indispensable for the vehicle HV to automatically continue traveling is suggested.

When the necessity determination section 112 determines that a driver action is necessary under the condition where a lane change indispensable for continuing traveling is performed, the necessity determination section 112 outputs a request notification indicating that approval by the driver for the lane change indispensable for continuing traveling is necessary to the transmission processing section 113. On the other hand, when the necessity determination section 112 determines that a driver action is necessary under the condition where a lane change or passing dispensable for continuing traveling is suggested, the necessity determination section 112 outputs a request notification indicating that approval by the driver for the lane change or passing dispensable for continuing traveling is necessary to the transmission processing section 113.

The display control section 201 of the portable terminal 2 causes the display unit 210 to perform an assistance display corresponding to the details of the driver action included in the request notification transmitted from the vehicle-side unit 1. An assistance display corresponding to the control-related request described above is performed with respect to the request notification indicating that approval by the driver for the lane change indispensable for continuing traveling is necessary. On the other hand, an assistance display corresponding to the control-related suggestion described above is performed with respect to the request notification indicating that approval by the driver for a lane change or passing dispensable for continuing traveling is necessary.

The approval by the driver may be performed by operating the blinker lever or operating the operation device 12 as described above. In the configuration of the second modification, the direction of a lane change or passing performed by the vehicle HV may also be transmitted when the request notification is transmitted from the vehicle-side unit 1 to the portable terminal 2, and an assistance display corresponding to the direction of the lane change or passing performed by the vehicle HV may be performed in the portable terminal 2.

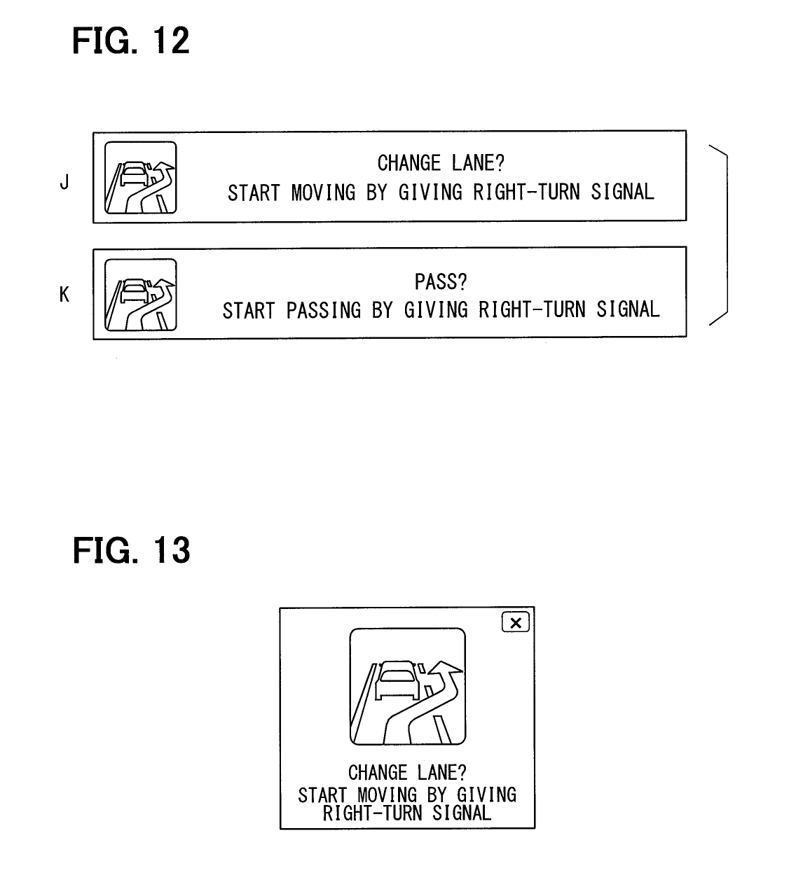

As an example of the assistance display corresponding to the control-related suggestion in the second modification, a banner display that is a combination of text with an icon as illustrated in FIG. 12 may be performed. In FIG. 12, “J” is an example of the assistance display in a case where a lane change in the right direction is suggested, and “K” is an example of the assistance display in a case where passing is suggested. Alternatively, a pop-up display that is a combination of text with an icon as illustrated in FIG. 13 may be performed. FIG. 13 illustrates an example in a case where a lane change in the right direction is suggested. When the assistance display corresponding to the control-related request is performed, the contents of the text illustrated in FIGS. 12 to 13 may be changed from a question to a request.

Third Modification

When the approval by the driver for a stop on a road shoulder with an approach of an emergency vehicle is necessary, the necessity determination section 112 may determine that a driver action is necessary during automatic driving (hereinbelow, referred to as a third modification).

Hereinbelow, the configuration of the third modification of the present disclosure will be described. In the third modification, the vehicle-side unit 1 includes a communication module which communicates with the outside of the vehicle HV. The communication module successively receives positional information of an emergency vehicle, the positional information being successively transmitted from the emergency vehicle, as an example. The HCU 11 detects an approach of the emergency vehicle to the own vehicle by a known method using the positional information of the emergency vehicle successively received by the communication module and the own vehicle position measured by the ADAS locator 30. As an example, the approach of the emergency vehicle may be detected when the own vehicle and the emergency vehicle are located on the same link, the own vehicle is located on a route of the emergency vehicle, and the distance between the own vehicle and the emergency vehicle is less than a threshold of, for example, several dozen meters.

The necessity determination section 112 of the third modification determines that a driver action is necessary during automatic driving when the HCU 11 detects an approach of an emergency vehicle and the own vehicle position is not near an intersection. Whether the own vehicle position is near an intersection may be determined on the basis of whether the distance between the own vehicle position measured by the ADAS locator 30 and a node indicating the intersection is equal to or more than a threshold for determining whether the own vehicle position is near an intersection. When the necessity determination section 112 of the third modification determines that a driver action is necessary under the condition where an approach of an emergency vehicle has been detected, the necessity determination section 112 outputs a request notification indicating that approval by the driver for a stop on a road shoulder is necessary to the transmission processing section 113.

The display control section 201 of the portable terminal 2 causes the display unit 210 to perform an assistance display corresponding to the details of the driver action included in the request notification transmitted from the vehicle-side unit 1. An assistance display corresponding to the control-related suggestion described above is performed with respect to the request notification indicating that approval by the driver for the stop on the road shoulder is necessary. As a concrete example, an assistance display representing the approach of the emergency vehicle and a suggestion of the stop on the road shoulder may be performed. The approval by the driver may be performed by operating the blinker lever or operating the operation device 12 as described above. The rejection by the driver may be performed by operating the operation device 12 as described above.

When the approval by the driver is performed, the automatic driving ECU 60 brings the own vehicle close to the road shoulder and stops the own vehicle. Also when the rejection by the driver is performed, the automatic driving ECU 60 preferably brings the own vehicle close to the road shoulder so that the own vehicle travels near the road shoulder under the condition where the approach of the emergency vehicle has been detected.

Fourth Modification

When an approval operation by the driver is necessary in merging into a main through lane during automatic driving, the necessity determination section 112 may determine that a driver action is necessary during automatic driving in merging into the main through lane during automatic driving (hereinbelow, referred to as a fourth modification).

Hereinbelow, the configuration of the fourth modification of the present disclosure will be described. The necessity determination section 112 of the fourth modification may determine that a driver action is necessary during automatic driving when the vehicle HV automatically merges into a main through lane on the basis of a travel plan generated in the automatic driving ECU 60. When the necessity determination section 112 of the fourth modification determines that a driver action is necessary under the condition where the vehicle HV automatically merges into a main through lane, the necessity determination section 112 outputs a request notification indicating that approval by the driver for the merging into the main through lane is necessary to the transmission processing section 113.

The display control section 201 of the portable terminal 2 causes the display unit 210 to perform an assistance display corresponding to the details of the driver action included in the request notification transmitted from the vehicle-side unit 1. An assistance display corresponding to the control-related request described above is performed with respect to the request notification indicating that approval by the driver for the merging into the main through lane is necessary.

The approval by the driver may be performed by operating the blinker lever or operating the operation device 12 as described above. In the configuration of the fourth modification, information indicating that merging into the main through lane is performed may also be transmitted when the request notification is transmitted from the vehicle-side unit 1 to the portable terminal 2, and an assistance display corresponding to the merging into the main through lane may be performed in the portable terminal 2.

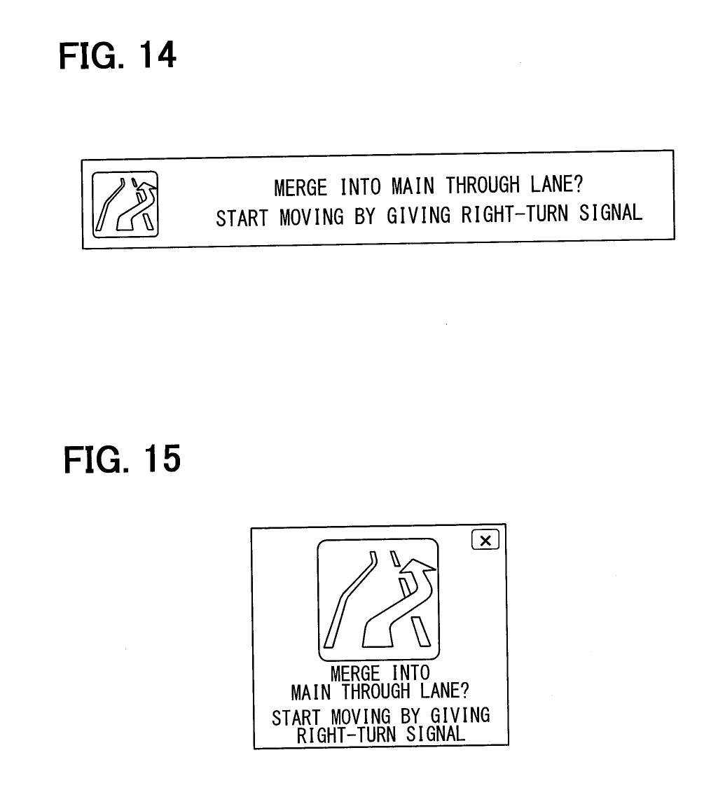

The assistance display in the fourth modification may be a banner display that is a combination of text with an icon as illustrated in FIG. 14 or may be a pop-up display that is a combination of text with an icon as illustrated in FIG. 15.

Fifth Modification

When a remaining distance and/or a remaining time to an available stop-by point becomes equal to or less than a set value during automatic driving and a stop-by at the available stop-by point is suggested, the necessity determination section 112 may determine that a driver action is necessary during automatic driving (hereinbelow, referred to as the fifth modification). Examples of the available stop-by point include a service area (hereinbelow, referred to as an SA) and a parking area (hereinbelow, referred to as a PA). Hereinbelow, a description will be made with an example of the SA.

Hereinbelow, the configuration of the fifth modification of the present disclosure will be described. The necessity determination section 112 of the fourth modification acquires a remaining distance to the nearest SA ahead in the traveling direction on the basis of a travel plan of the automatic driving ECU 60 and map data. When the remaining distance or a remaining time calculated from the remaining distance is equal to or less than a set value, it is determined that a driver action is necessary during automatic driving. The remaining time may be calculated by the necessity determination section 112 from the remaining distance and an average vehicle speed. The set value described herein is settable in any manner.

When the necessity determination section 112 of the fifth modification determines that the driver action is necessary under the condition where the remaining distance and/or the remaining time to the available stop-by point becomes equal to or less than the set value, the necessity determination section 112 outputs a request notification indicating that approval by the driver for a stop-by at the available stop-by point is necessary to the transmission processing section 113.

The display control section 201 of the portable terminal 2 causes the display unit 210 to perform an assistance display corresponding to the details of the driver action included in the request notification transmitted from the vehicle-side unit 1. An assistance display corresponding to the control-unrelated suggestion described above is performed with respect to the request notification indicating that approval by the driver for the stop-by at the available stop-by point is necessary. As a concrete example, an assistance display representing a suggestion of the stop-by at the available stop-by point may be performed. The approval or rejection by the driver may be performed by operating the operation device 12 or the portable terminal 2 as described above.

In the configuration of the fifth modification, the remaining distance and/or the remaining time to the SA may also be transmitted when the request notification is transmitted from the vehicle-side unit 1 to the portable terminal 2, and the remaining distance and/or the remaining time may also be displayed when the assistance display is performed in the portable terminal 2. Further, a remaining distance and/or a remaining time to switching from automatic driving to manual driving may also be transmitted in addition to the remaining distance and/or the remaining time to the SA, and the remaining distances and/or the remaining times may be displayed.

An example of the flow of an operation necessity-related process in the HCU 11 in the fifth modification is similar to the flow of the operation necessity-related process in the HCU 11 in the first modification illustrated in FIG. 11 except that the distance and the time to a SA is used instead of the distance and the time to an automatic driving section end.

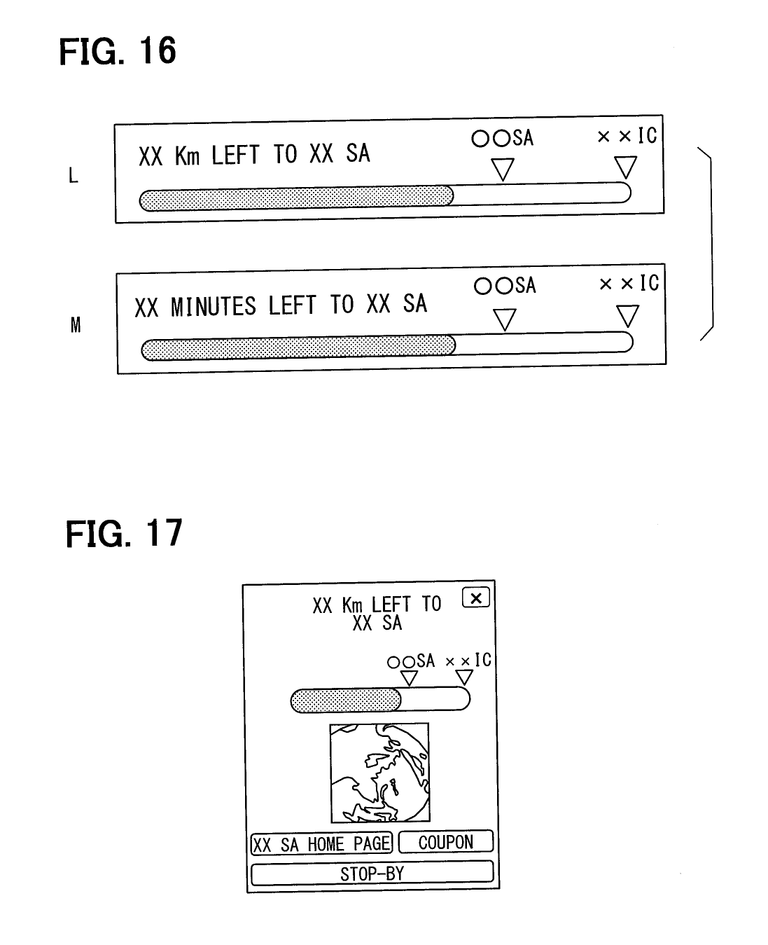

As an example of the assistance display corresponding to the control-unrelated suggestion in the fifth modification, a banner display that is a combination of text with an image as illustrated in FIG. 16 may be performed. In FIG. 16, “L” is an example in a case where the remaining distance to the SA is shown and includes an image that indicates both of the distance to the automatic driving section end (IC in the drawing) and the distance to the SA. In FIG. 16, “M” is an example in a case where the remaining time to the SA is shown and includes an image that indicates both of the time to the automatic driving section end (IC in the drawing) and the time to the SA. When the driver who sees such a banner display has an intention to stop by the SA, for example, the driver may operate the operation device 12 to notify the HCU 11 of the intention of approving the stop-by. When the stop-by is approved, the HCU 11 may provide an instruction to stop by the SA to the automatic driving ECU 60.

Alternatively, a pop-up display that is a combination of text with an image as illustrated in FIG. 17 may be performed. FIG. 17 illustrates an example in a case where the remaining distance to the SA is shown. In the example of FIG. 17, the pop-up display includes an image that indicates both of the distance to the automatic driving section end (IC in the drawing) and the distance to the SA, an image that indicates information of the SA, and a button display. The button display functions as a touch switch. When the driver who sees such a pop-up display has an intention to stop by the SA, for example, the driver may operate the button display of a “stop-by” button in the pop-up display to notify the portable terminal 2 of the intention of approving the stop-by. When the driver has no intention to stop by, for example, the driver may operate a button display that indicates closing in the pop-up display to notify the portable terminal 2 of the intention of rejecting the stop-by. The intention of rejecting the stop-by may be notified to the portable terminal 2 by not operating the button display of the “stop-by” button for a certain time or more after the start of the assistance display.

When the stop-by is approved, the portable terminal 2 transmits information indicating that the driver has an intention to stop by the SA to the HCU 11 through the commination device 20. When the HCU 11 acquires the information indicating that the driver has an intention to stop by the SA, the HCU 11 may provide an instruction to stop by the SA to the automatic driving ECU 60. When the stop-by is rejected, the portable terminal 2 transmits information indicating that the driver has no intention to stop by the SA to the HCU 11 through the commination device 20. When the HCU 11 acquires the information indicating that the driver has no intention to stop by the SA, the HCU 11 may provide an instruction to continue automatic driving without stopping by the SA to the automatic driving ECU 60.

Sixth Modification

When approval or selection by the driver for a route change of automatic driving is necessary, the necessity determination section 112 may determine that a driver action is necessary during automatic driving (hereinbelow, referred to as a sixth modification).

Hereinbelow, the configuration of the sixth modification of the present disclosure will be described. In the sixth modification, the vehicle-side unit 1 is capable of displaying a recommended route generated in the automatic driving ECU 60 on the display device 14. Also after the generated recommended route is set as a route of automatic driving, the automatic driving ECU 60 newly generates a recommended route candidate. As an example, the vehicle-side unit 1 includes a communication module that acquires traffic information and weather information from a center, and the automatic driving ECU 60 newly generates a recommended route candidate for avoiding traffic jam and a heavy rain region on the basis of the traffic information and the weather information acquired by the communication module.

When the automatic driving ECU 60 generates a recommended route candidate that differs from an automatic driving route that has been already set, the necessity determination section 112 of the sixth modification determines that a driver action is necessary during automatic driving. When the necessity determination section 112 of the sixth modification determines that a driver action is necessary under the condition where the automatic driving ECU 60 generates the recommended route candidate that differs from the automatic driving route that has been already set, the necessity determination section 112 outputs a request notification indicating that approval or selection by the driver for performing a route change of automatic driving to the generated recommenced route candidate to the transmission processing section 113. When there is one recommended route candidate, the request notification may indicate that approval for the route change of automatic driving is necessary. When there are a plurality of recommended route candidates, the request notification may indicate that candidate selection for the route change of automatic driving is necessary.

The display control section 201 of the portable terminal 2 causes the display unit 210 to perform an assistance display corresponding to the details of the driver action included in the request notification transmitted from the vehicle-side unit 1. An assistance display corresponding to the control-unrelated suggestion described above is performed with respect to the request notification indicating that approval or selection of a recommended route candidate is necessary. As a concrete example, an assistance display representing a suggestion of the route change of automatic driving may be performed. The approval, selection, or rejection by the driver may be performed by operating the operation device 12 or operating the portable terminal 2 as described above.

In the configuration of the sixth modification, information of a recommended route candidate may also be transmitted when the request notification is transmitted from the vehicle-side unit 1 to the portable terminal 2, and the information of the recommended route candidate may also be displayed when the assistance display is performed in the portable terminal 2. When there is one recommended route candidate, the driver may approve or reject the candidate. When there are a plurality of recommended route candidates, the driver may select any of the candidates or reject the candidates.

When the operation device 12 receives the approval, selection, or rejection, the automatic driving ECU 60 may change the route of automatic driving to the approved or selected recommended route. On the other hand, when the portable terminal 2 receives the approval, selection, or rejection, the portable terminal 2 transmits information of the approved or selected recommended route to the automatic driving ECU 60 through the communication device 20. When the automatic driving ECU 60 acquires the information of the approved or selected recommended route, the automatic driving ECU 60 may change the route of automatic driving to the approved or selected recommended route.

Seventh Modification

When a confirmation of the driver to information provision is necessary, the necessity determination section 112 may determine that a driver action is necessary during automatic driving (hereinbelow, referred to as a seventh modification).

Hereinbelow, the configuration of the seventh modification of the present disclosure will be described. In the seventh modification, the automatic driving ECU 60 successively calculates an estimated destination arrival time in a generated recommended route. The calculation of the estimated destination arrival time may be performed in a manner similar to calculation of an estimated destination arrival time performed in a known navigation device. The vehicle-side unit 1 is capable of displaying the estimated destination arrival time in the recommended route generated by the automatic driving ECU 60 on the display device 14.

When the estimated destination arrival time is changed by a certain time, for example, 10 minutes or more, the necessity determination section 112 of the seventh modification determines that a driver action is necessary during automatic driving. As an example, when a calculation result of a new estimated destination arrival time is changed by a certain time or more from a calculation result of the latest past estimated destination arrival time, the necessity determination section 112 may determine that a driver action is necessary during automatic driving. Alternatively, when a calculation result of a new estimated destination arrival time is changed by a certain time or more from a calculation result of the latest estimated destination arrival time displayed on the display device 14, the necessity determination section 112 may determine that a driver action is necessary during automatic driving. When the estimated destination arrival time is changed by a certain time or more, the necessity determination section 112 of the seventh modification outputs a request notification indicating that a confirmation by the driver for the changed estimated destination arrival time is necessary to the transmission processing section 113.

The display control section 201 of the portable terminal 2 causes the display unit 210 to perform an assistance display corresponding to the details of the driver action included in the request notification transmitted from the vehicle-side unit 1. An assistance display corresponding to the information provision described above is performed with respect to the request notification indicating that a confirmation by the driver for the changed estimated destination arrival time is necessary. As a concrete example, an assistance display representing the changed estimated destination arrival time may be performed. The confirmed intention of the driver may be transmitted by operating the operation device 12 or operating the portable terminal 2 as described above. In the configuration of the seventh modification, the changed estimated destination arrival time may also be transmitted when the request notification is transmitted from the vehicle-side unit 1 to the portable terminal 2, and the estimated destination arrival time may also be displayed when the assistance display is performed in the portable terminal 2.

When the HCU 11 detects an approach of an emergency vehicle as described in the third modification, the necessity determination section 112 may determine that a driver action is necessary during automatic driving regardless of whether the own vehicle is located near an intersection. In this case, the necessity determination section 112 may output a request notification indicating that a confirmation by the driver for a notification notifying the approach of the emergency vehicle is necessary to the transmission processing section 113. The display control section 201 of the portable terminal 2 may perform an assistance display that notifies the approach of the emergency vehicle as the assistance display corresponding to the information provision described above.

Eighth Modification

The first to seventh modifications may be combined. The present disclosure is applicable not only to the examples described in the first embodiment and the first to seventh modifications, but also to all conditions where an operation by the driver is necessary during automatic driving.

Ninth Modification

When display timings of a plurality of types of assistance displays overlap each other in the configuration in which the first embodiment and the first to seventh modifications are combined, the following configuration may be employed as an example. As described above, the assistance display includes four types of assistance displays: the control-related request; the control-related suggestion; the control-unrelated suggestion; and the information provision. Further, the control-related request, the control-related suggestion, the control-unrelated suggestion, and the information provision have higher priorities in this order.

When display timings of a plurality of types of assistance displays overlap each other, the display control section 201 may display assistance information of the type having a higher priority in preference to the others. Accordingly, assistance information of the type having a higher priority can attract the driver's attention in preference to the others.

As an example of the priority, assistance information of the type having a higher priority may be displayed prior to the others. Specifically, among the assistance displays whose display timings overlap each other, only the assistance display of the type having the highest priority is displayed. Then, a process in which, when the assistance display is finished, only the assistance display of the type having the second highest priority is displayed among the assistance displays whose display timings overlap each other may be repeated. As another example of the priority, the assistance displays whose display timings overlap each other may be simultaneously displayed in respective different display areas, and the assistance display of the type having a higher priority may be displayed larger.

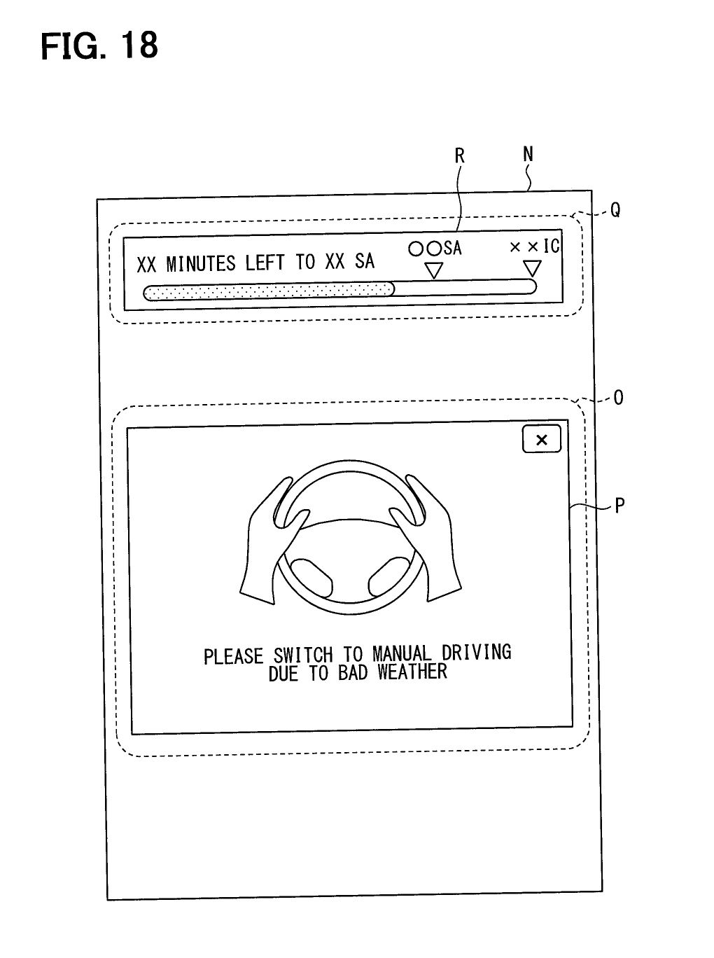

Further, when display timings of assistance information items of types having a common display area overlap each other, the assistance information item of the type having a higher priority may be displayed prior to the others. On the other hand, when display timings of assistance information items of types having difference display areas overlap each other, the assistance information item of the type having a higher priority may be displayed larger. An example of the configuration will be described with reference to FIG. 18. In FIG. 18, “N” indicates a display screen of the portable terminal 2, and “O” and “Q” indicate respective different display areas. Further, in FIG. 18, “P” indicates a display of the control-related request, and “R” indicates a display of the control-unrelated suggestion.

The display area O displays the control-related request. The display area Q displays the control-related suggestion, the control-unrelated suggestion, and the information provision. The control-related request is an assistance display for making a request that necessarily needs to be performed by the driver. Thus, the control-related request is displayed large so as to be conspicuous (refer to “P” in FIG. 18). On the other hand, the control-related suggestion, the control-unrelated suggestion, and the information provision are assistance displays for performing suggestions and information provision that do not necessarily need to be performed by the driver. Thus, the control-related suggestion, the control-unrelated suggestion, and the information provision are displayed smaller than the control-related request. Also when display timings of the control-related request and an assistance display displayed in the display area Q overlap each other, the control-related request is displayed larger than the assistance display in the display area Q. Thus, the control-related request is more conspicuous. When the control-related request is displayed, no assistance display may be displayed in the display area Q.

The control-related suggestion, the control-unrelated suggestion, and the information provision have the common display area Q. Thus, when display timings of the control-related suggestion, the control-unrelated suggestion, and the information provision overlap each other, the assistance information of the type having a higher priority is displayed prior to the others. When display timings of the control-unrelated suggestion and the information provision overlap each other, the control-unrelated suggestion is displayed prior to the information provision (refer to “R” in FIG. 18). Accordingly, the assistance display having a higher priority among the control-related suggestion, the control-unrelated suggestion, and the information provision attracts the driver's attention prior to the others. According the configuration illustrated in FIG. 18 as an example, it is possible to effectively utilize a small display area by ensuring a display area for displaying the assistance display having the highest priority large so as to be most conspicuous and also displaying the group of the assistance displays having lower priorities in the descending order of priorities.

### Second Embodiment

The first embodiment and the first to ninth modifications describe the configuration in which the vehicle-side unit 1 and the portable terminal 2 exchange information therebetween by short-range wireless communication. However, the present disclosure is not limited thereto. For example, information may be exchanged by communication performed by indirect connection through a device outside the vehicle HV (hereinbelow, referred to as a second embodiment).

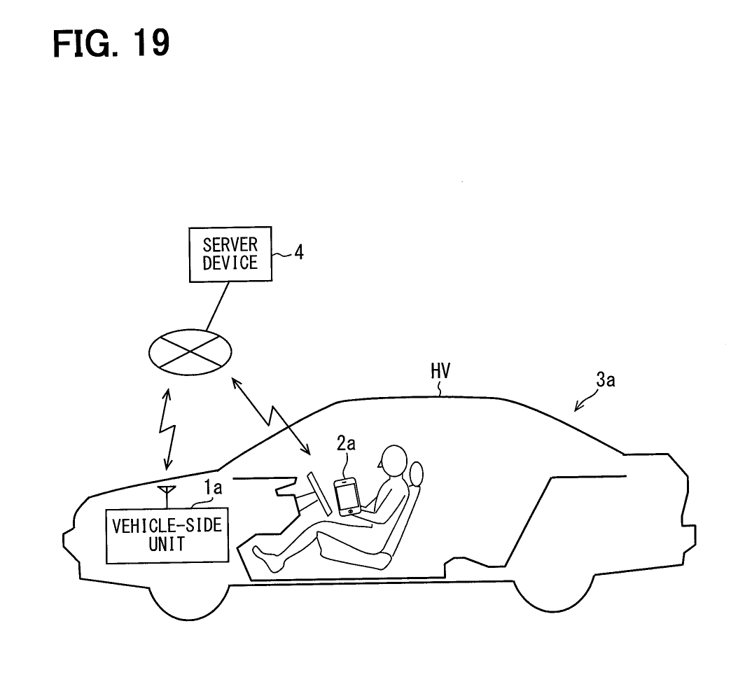

Hereinbelow, an example of the configuration of the second embodiment of the present disclosure will be described. As illustrated in FIG. 19, an assistance system 3 of the second embodiment includes a vehicle-side unit 1a, a portable terminal 2a, and a server device 4. The vehicle-side unit 1a is similar to the vehicle-side unit 1 of the first embodiment except that the vehicle-side unit 1a includes an HMI system 10a instead of the HMI system 10 and includes a communication device 20a instead of the communication device 20. The portable terminal 2a is similar to the portable terminal 2 of the first embodiment except that the portable terminal 2a includes a main control unit 200a instead of the main control unit 200 and includes a communication unit 230a instead of the communication unit 230.

The vehicle-side unit 1a and the portable terminal 2a are indirectly connected to each other through the server device 4 to perform communication. The vehicle-side unit 1a and the portable terminal 2a may communicate with the server device 4 through a public communication network such as the cellular phone network or the Internet. The server device 4 transmits information received from the vehicle-side unit 1a to the portable terminal 2a and transmits information received from the portable terminal 2a to the vehicle-side unit 1a. The server device 4 corresponds to the device outside the vehicle.

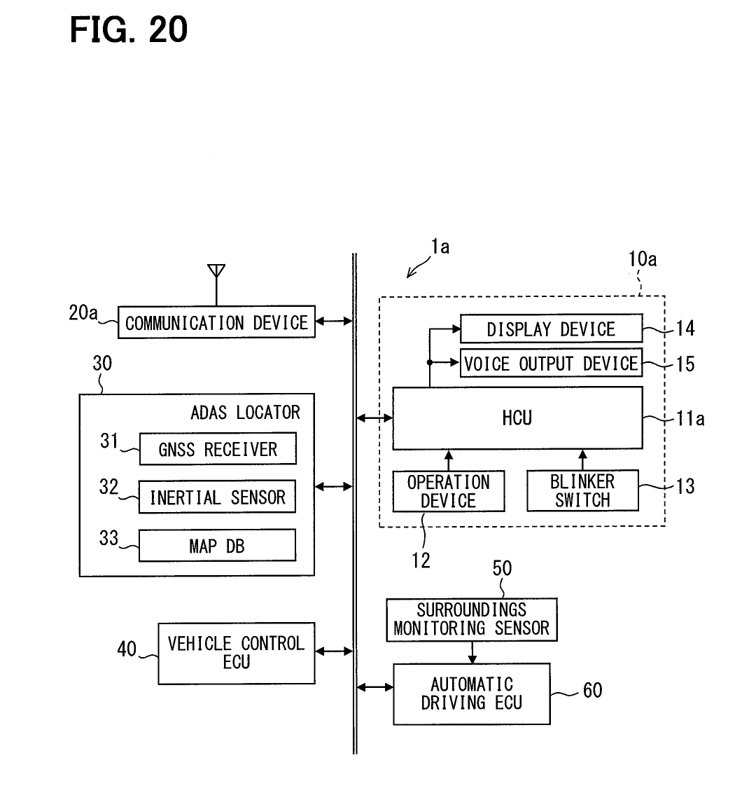

First, a schematic configuration of the vehicle-side unit 1a will be described with reference to FIG. 20. The vehicle-side unit 1a includes the HMI system 10a, the communication device 20a, an ADAS locator 30, a vehicle control ECU 40, a surroundings monitoring sensor 50, and an automatic driving ECU 60. The HMI system 10a is similar to the HMI system 10 of the first embodiment except that the HMI system 10a includes an HCU 11a instead of the HCU 11.

The communication device 20a is a communication module for performing communication with the server device 4 through the public communication network. The communication device 20a outputs information received from the server device 4 to an in-vehicle LAN and transmits information transmitted from the HCU 11a through the in-vehicle LAN to the server device 4.

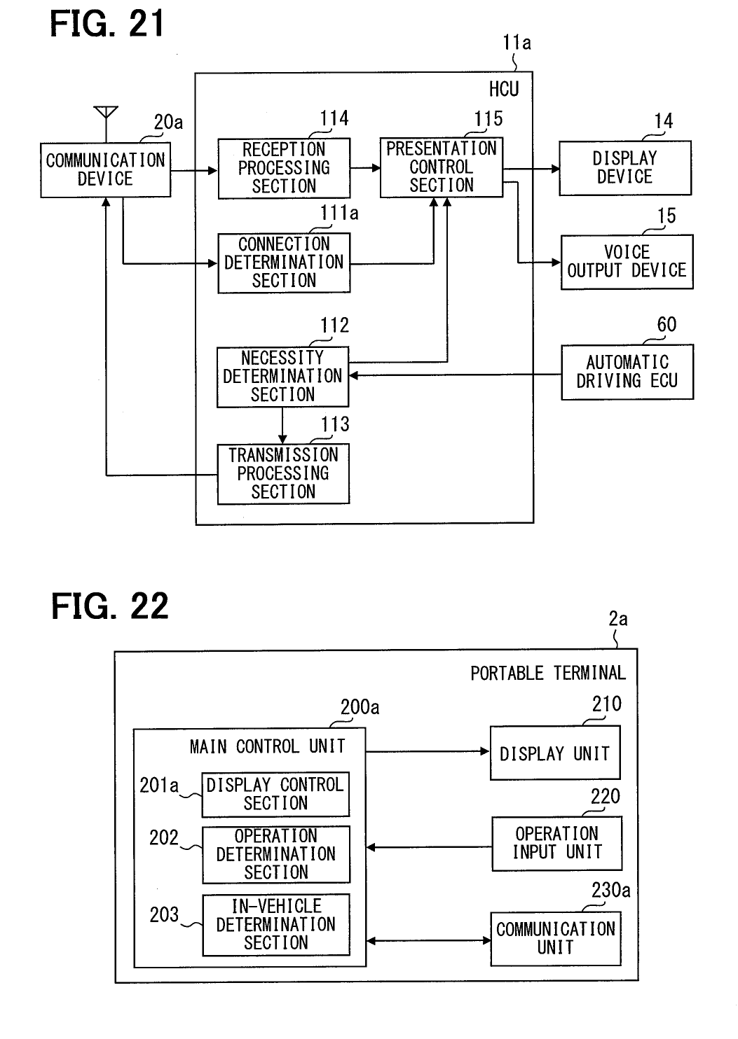

As illustrated in FIG. 21, the HCU 11a includes a connection determination section 111a, a necessity determination section 112, a transmission processing section 113, a reception processing section 114, and a presentation control section 115. The HCU 11a is similar to the HCU 11 of the first embodiment except that the HCU 11a includes the connection determination section 111a instead of the connection determination section 111. The connection determination section 111a monitors the state of the communication device 20 to determine whether connection with the portable terminal 2 through the server device 4 is possible.

Next, a schematic configuration of the portable terminal 2a will be described with reference to FIG. 22. The portable terminal 2a includes the main control unit 200a, a display unit 210, an operation input unit 220, and the communication unit 230a. The main control unit 200a includes a display control section 201a, an operation determination section 202, and an in-vehicle determination section 203 as functional blocks. The main control unit 200a is similar to the main control unit 200 of the first embodiment except that the main control unit 200a includes the display control section 201a instead of the display control section 201 and includes the in-vehicle determination section 203.

The communication unit 230a communicates with the communication device 20a of the vehicle-side unit 1a through the server device 4. When the communication unit 230a receives a request notification from the communication device 20a, the communication unit 230a outputs the received request notification to the main control unit 200a. When the main control unit 200a outputs portable terminal operation information, the communication unit 230a transmits the information to the communication device 20a.

The in-vehicle determination section 203 determines whether the portable terminal 2a is being used inside the vehicle. As an example, when the portable terminal 2a has a positioning function such as a GPS function, the following operation may be performed. For example, the in-vehicle determination section 203 calculates a moving speed of the own terminal from the amount of change with respect to time in the position of the own terminal successively detected by the positioning function. When the calculated moving speed is equal to or higher than a threshold, the in-vehicle determination section 203 determines that the portable terminal 2a is being used inside the vehicle. The threshold described herein may be a speed that is high enough not to be detected in a movement by walking or a bicycle. As another example, when the operation input unit 220 receives an operation input indicating that the portable terminal 2a has been carried into the vehicle HV, the in-vehicle determination section 203 may determine that the portable terminal 2a is being used inside the vehicle.

The operation determination section 202 of the second embodiment determines whether the own terminal is being operated when the in-vehicle determination section 203 determines that the portable terminal 2a is being used inside the vehicle and the operation determination section 202 acquires the request notification output from the communication unit 230. On the other hand, the operation determination section 202 does not determine whether the own terminal is being operated when the in-vehicle determination section 203 determines that the portable terminal 2a is not being used inside the vehicle or the operation determination section 202 acquires no request notification output from the communication unit 230. Accordingly, it is possible to prevent an assistance display from being performed in the portable terminal 2a when the portable terminal 2a is not being used inside the vehicle.

Also in the configuration of the second embodiment, when the portable terminal 2a receives a request notification from the vehicle-side unit 1a and the portable terminal 2a determines that the own terminal is being operated, the assistance display is performed in the display unit 210 of the portable terminal 2a. Thus, in a manner similar to the configuration of the first embodiment, even when the driver is operating the portable terminal 2a carried into the vehicle HV, a driver action that is necessary during automatic driving can be more smoothly executed.

Tenth Modification

The embodiments and the modifications described above describe the configuration in which when the portable terminals 2, 2a receive a request notification, a determination result in the operation determination section 202 is transmitted to the vehicle-side units 1, 1a. However, the present disclosure is not necessarily limited thereto. For example, when the portable terminals 2, 2a receive a request notification, a determination result in the operation determination section 202 (that is, the portable terminal operation information) may not be transmitted to the vehicle-side units 1, 1a from the portable terminals 2, 2a (hereinbelow, referred to as a tenth modification).

When the tenth modification is employed, the process using the portable terminal operation information in the HCUs 11, 11a of the vehicle-side units 1, 1a may be omitted. That is, assistance presentation may be performed regardless of whether the portable terminals 2, 2a are being operated. In this case, when the necessity determination section 112 determines that an operation by the driver is necessary and the connection determination sections 111, 111a determine that connection with the portable terminals 2, 2a is impossible, the presentation control section 115 may perform assistance presentation. When the necessity determination section 112 determines that an operation by the driver is necessary and the connection determination sections 111, 111a determine that connection with the portable terminals 2, 2a is possible, assistance presentation may not be performed.

Eleventh Modification

The embodiments and the modifications described above describe the configuration in which the presentation control section 115 makes a change between execution and inexecution of assistance presentation depending on whether the connection determination sections 111, 111a determine that connection with the portable terminals 2, 2a is possible. However, the present disclosure is not limited thereto. For example, assistance presentation may be performed regardless of whether the communication devices 20, 20a of the vehicle-side units 1, 1a and the portable terminals 2, 2a are connectable. In this case, the HCUs 11, 11a may not include the connection determination sections 111, 111a.

Further, assistance presentation from the display device 14 may be performed regardless of whether the communication devices 20, 20a and the portable terminals 2, 2a are connectable. On the other hand, execution and inexecution of assistance presentation from the voice output device 15 may be changed depending on whether the communication devices 20, 20a and the portable terminals 2, 2a are connectable. Specifically, when the communication devices 20, 20a and the portable terminals 2, 2a are connectable, assistance presentation from the voice output device 15 may not be performed. On the other hand, when the communication devices 20, 20a and the portable terminals 2, 2a are unconnectable, assistance presentation from the voice output device 15 may be performed. This is because of the following reason. The assistance presentation from the display device 14 is less likely to attract the attention of the driver who is operating the portable terminals 2, 2a and thus less likely to cause troublesomeness. On the other hand, the assistance presentation from the voice output device 15 reaches the driver's ears and thus likely to cause troublesomeness.

### Third Embodiment

The embodiments and the modifications described above describe the configuration in which the portable terminal 2 determines whether the portable terminal 2 is being operated. However, the present disclosure is not necessarily limited thereto. For example, the vehicle-side unit 1 may determine whether the portable terminal 2 is being operated (hereinbelow, referred to as a third embodiment).

Hereinbelow, an example of the configuration of the third embodiment of the present disclosure will be described. An assistance system 3 of the third embodiment includes a vehicle-side unit 1 and a portable terminal 2b. The vehicle-side unit 1 of the third embodiment is similar to the vehicle-side unit 1 of the first embodiment except that the vehicle-side unit 1 of the third embodiment includes an HCU 11a instead of the HCU 11. The portable terminal 2b is similar to the portable terminal 2 of the first embodiment except that the portable terminal 2b includes a main control unit 200b instead of the main control unit 200 and includes an operation information acquisition section 204 instead of the operation determination section 202.

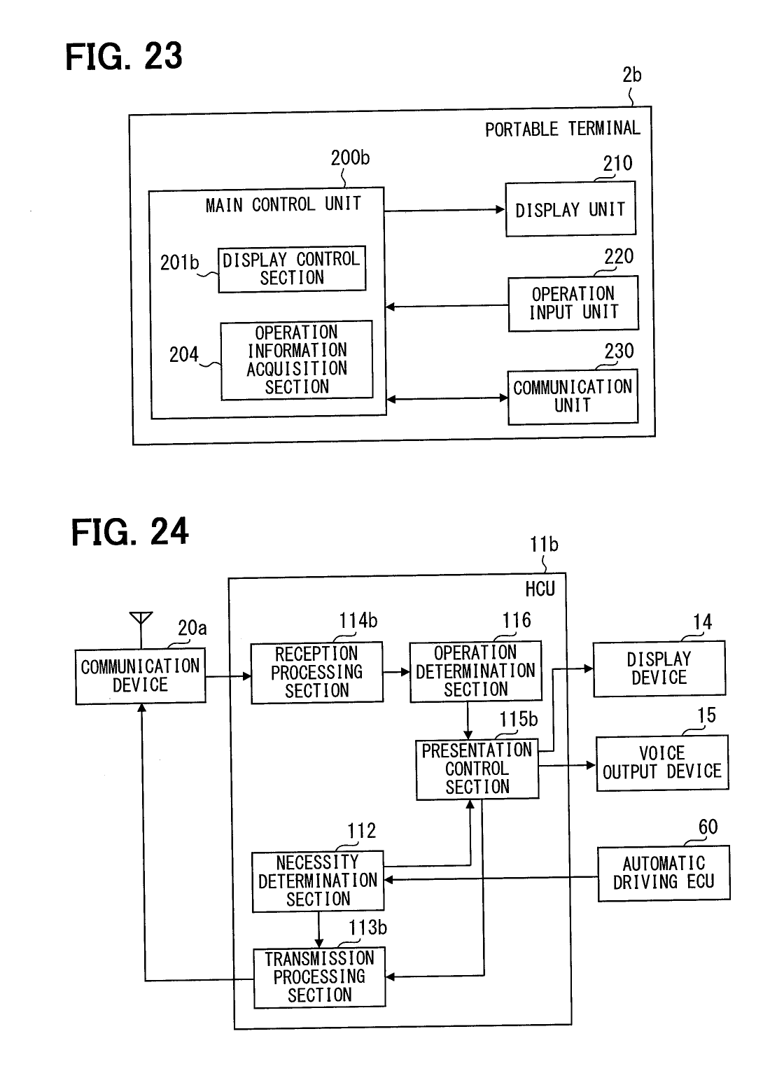

First, a schematic configuration of the portable terminal 2b will be described with reference to FIG. 23. The portable terminal 2b includes the main control unit 200b, a display unit 210, an operation input unit 220, and a communication unit 230. The main control unit 200b includes a display control section 201b and the operation information acquisition section 204 as functional blocks. The main control unit 200b is similar to the main control unit 200 of the first embodiment except that the main control unit 200b includes the display control section 201b instead of the display control section 201 and includes the operation information acquisition section 204 instead of the operation determination section 202.

When the operation information acquisition section 204 acquires a request notification output from the communication unit 230, the operation information acquisition section 204 acquires information that enables the HCU lib to determine whether the portable terminal 2b is being operated (hereinbelow, referred to as determination information). Examples of the determination information include information indicating whether the display control section 201 shifts to a sleep mode and information indicating whether the operation input unit 220 receives an operation input.

When the display control section 201b acquires an assistance instruction (described below) output from the communication unit 230, the display control section 201b causes the display unit 210 to perform an assistance display. On the other hand, when the display control section 201b acquires no assistance instruction, the display control section 201b does not cause the display unit 210 to perform an assistance display.

Next, a schematic configuration of the HCU 11b will be described with reference to FIG. 24. The HCU 11b includes a necessity determination section 112, a transmission processing section 113b, a reception processing section 114b, a presentation control section 115b, and an operation determination section 116. The HCU 11b is similar to the HCU 11 of the first embodiment except that the HCU 11b includes the transmission processing section 113b, the reception processing section 114b, and the presentation control section 115b instead of the transmission processing section 113, the reception processing section 114, and the presentation control section 115 and includes the operation determination section 116 instead of the connection determination section 111.

When the transmission processing section 113b acquires a request notification from the necessity determination section 112, the transmission processing section 113b causes the communication device 20 to transmit the request notification to the portable terminal 2b. Further, when the transmission processing section 113b acquires an instruction for performing an assistance display from the presentation control section 115b (hereinbelow, referred to as an assistance instruction), the transmission processing section 113b causes the communication device 20 to transmit the assistance instruction to the portable terminal 2b. The transmission processing section 113b corresponds to the instruction processing section.

When the communication device 20 receives determination information transmitted from the portable terminal 2b, the reception processing section 114b acquires the determination information and outputs the acquired determination information to the operation determination section 116. The reception processing section 114b corresponds to the determination information acquisition section. When the reception processing section 114 outputs the determination information, the operation determination section 116 determines whether the portable terminal 2b is being operated on the basis of the determination information in a manner similar to the determination by the operation determination section 202.

When the operation determination section 116 determines that the portable terminal 2b is being operated, the presentation control section 115b outputs an assistance instruction to the transmission processing section 113b. On the other hand, when the operation determination section 116 determines that the portable terminal 2b is not being operated, the presentation control section 115b outputs no assistance instruction to the transmission processing section 113b. Accordingly, when the operation determination section 116 determines that the portable terminal 2b is being operated, an assistance instruction is transmitted to the portable terminal 2b, and an assistance display is performed in the display unit 210 of the portable terminal 2b.

When the necessity determination section 112 determines that an operation by the driver is necessary, the presentation control section 115b performs assistance presentation in accordance with a condition. As an example, when the reception processing section 114b cannot receive determination information within a predetermined time after the transmission processing section 113b transmits a request notification, the presentation control section 115b causes the display device 14 and/or the voice output device 15 to perform assistance presentation. The predetermined time described herein may be a time that is longer than a time required for transmitting determination information in response to the request notification in a case where the communication device 20 and the portable terminal 2b are connected. Also when the operation determination section 116 determines that the portable terminal 2b is not being operated, the presentation control section 115b causes the display device 14 and/or the voice output device 15 to perform assistance presentation. On the other hand, when the operation determination section 116 determines that the portable terminal 2b is being operated, the presentation control section 115b does not cause the display device 14 and/or the voice output device 15 to perform assistance presentation.

Also in the configuration of the second embodiment, when the portable terminal 2a receives a request notification from the vehicle-side unit 1a and the HCU 11b determines that the portable terminal 2a is being operated, the assistance display is performed in the display unit 210 of the portable terminal 2a. Thus, similarly to the configuration of the first embodiment, even when the driver is operating the portable terminal 2a carried into the vehicle HV, a driver action that is necessary during automatic driving can be more smoothly executed.

Twelfth Modification

The embodiments and the modifications described above describe the configuration in which assistance presentation is performed not only from the display device 14, but also from the voice output device 15. However, the present disclosure is not limited thereto. For example, assistance presentation may not be performed from the voice output device 15.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. An assistance system comprising:
an vehicular device for a vehicle that performs an autonomous driving operation for automatically controlling an acceleration operation, a braking operation and a steering operation, and allows a driver action including at least one of an operation, a response and a confirmation by a driver during the autonomous driving operation; and
a portable terminal that is carried by the driver of the vehicle and connected to the vehicular device to communicate with the vehicular device, wherein:
the vehicular device or the portable terminal includes an operation determination section that determines whether the portable terminal is being operated; and
the portable terminal includes a display unit that performs an assistance display for assisting an execution of the driver action which is required during the autonomous driving operation when the driver action is required during the autonomous driving operation, and the operation determination section determines that the portable terminal is being operated.

2. The assistance system according to claim 1, wherein:
the vehicular device includes a notification processing section for transmitting a request notification, which indicates that the driver action is required, to the portable terminal when the driver action is required during the autonomous driving operation, and the vehicular device is connectable with the portable terminal;
the portable terminal includes the operation determination section;
the operation determination section determines whether the portable terminal is being operated when the portable terminal receives the request notification; and
the display unit performs the assistance display when the operation determination section determines that the portable terminal is being operated.

3. The assistance system according to claim 1, wherein:
the vehicular device includes:
a determination information acquisition section that acquires determination information, for determining whether the portable terminal is being operated, from the portable terminal when the driver action is required during the autonomous driving operation, and the vehicular device is connectable with the portable terminal; and
the operation determination section;
the operation determination section determines whether the portable terminal is being operated, based on the determination information acquired by the determination information acquisition section;
the assistance system further comprising:
an instruction processing section that transmits an instruction for performing the assistance display to the portable terminal when the operation determination section determines that the portable terminal is being operated; and
the display unit of the portable terminal performs the assistance display when the portable terminal receives the instruction transmitted by the instruction processing section.

4. The assistance system according to claim 1 wherein:
the vehicular device and the portable terminal are directly connected to each other to perform short-range wireless communication.

5. The assistance system according to claim 2, wherein:
the vehicular device and the portable terminal are indirectly connected through an external device of the vehicle to perform communication;
the portable terminal includes an in-vehicle determination section that determines whether the portable terminal is being used inside the vehicle; and
the operation determination section determines whether the portable terminal is being operated when the portable terminal receives the request notification, and the in-vehicle determination section determines that the portable terminal is being used inside the vehicle.

6. The assistance system according to claim 1 wherein:
the assistance display includes at least one of a control-related request that requests the operation by the driver for controlling the vehicle, a control-related suggestion that makes a suggestion for controlling the vehicle to the driver, a control-unrelated suggestion that makes a suggestion unrelated to vehicle control to the driver, and information service that provides information to the driver, which are in a descending order of priority;
the display unit displays the assistance display having a higher priority in preference to others when display timings of a plurality of types of the assistance display overlap each other.

7. The assistance system according to claim 6, wherein:
when the display unit simultaneously displays the assistance display of the control-related request and the assistance display of a type other than the control-related request, the display unit displays the assistance display of the control-related request larger than the assistance display of the type other than the control-related request.

8. The assistance system according to claim 7, wherein:
when a plurality of types of the assistance display other than the control-related request have a same display area, and the display unit simultaneously displays the plurality of types of the assistance display other than the control-related request, the display unit displays a type of the assistance display having a higher priority in preference to others.

9. The assistance system according to claim 1, wherein:
a case where the driver action is required during the autonomous driving operation includes at least a case where the autonomous driving operation is switched to a manual driving operation in which the driver manually performs a driving operation; and
the display unit performs the assistance display for assisting a driving operation change from the autonomous driving operation to the manual driving operation when the autonomous driving operation is switched to the manual driving operation, and the operation determination section determines that the portable terminal is being operated.

10. The assistance system according to claim 1, wherein:
a case where the driver action is required during the autonomous driving operation includes at least a case where the response or the confirmation by the driver is required during the autonomous driving operation; and
the display unit performs the assistance display that assists an inquiry for requesting the response or the confirmation to the driver when the operation determination section determines that the portable terminal is being operated.

11. The assistance system according to claim 1, wherein:
the vehicular device includes a voice output processing section that controls a voice output device to output a voice;
the voice output processing section controls the voice output device to output the voice for assisting an execution of the driver action that is required during the autonomous driving operation when the driver action is required during the autonomous driving operation, and the vehicular device is not connectable with the portable terminal; and
the voice output processing section does not control the voice output device to output the voice for assisting the execution of the driver action that is required during the autonomous driving operation when the driver action is required during the autonomous driving operation, the vehicular device is connectable with the portable terminal, and the operation determination section determines that the portable terminal is being operated.

12. A portable terminal carried by a driver of a vehicle, the portable terminal comprising:
a communication unit for the vehicle that performs an autonomous driving operation for automatically controlling an acceleration operation, a braking operation and a steering operation, and allows a driver action including at least one of an operation, a response and a confirmation by the driver during the autonomous driving operation, the communication unit being connected to an vehicular device to perform communication with the vehicular device for transmitting a request notification, which indicates that the driver action is required when the driver action is required during the autonomous driving operation;
an operation determination section that determines whether the portable terminal is being operated when the communication unit receives the request notification; and
a display unit that performs an assistance display for assisting an execution of the driver action which is required during the autonomous driving operation when the operation determination section determines that the portable terminal is being operated.

13. An vehicular device for a vehicle that performs an autonomous driving operation for automatically controlling an acceleration operation, a braking operation and a steering operation, and allows a driver action including at least one of an operation, a response and a confirmation by a driver during the autonomous driving operation, the vehicular device being connected to a portable terminal carried by the driver of the vehicle to perform communication with the portable terminal, the vehicular device comprising:
a determination information acquisition section that acquires determination information, for determining whether the portable terminal is being operated, from the portable terminal when the driver action is required during the autonomous driving operation, and the vehicular device is connectable with the portable terminal;
an operation determination section that determines whether the portable terminal is being operated, based on the determination information acquired by the determination information acquisition section; and
an instruction processing section that transmits an instruction, for performing an assistance display that assists an execution of the driver action which is required during the autonomous driving operation, to the portable terminal when the operation determination section determines that the portable terminal is being operated.
